(19) United States
(12) Patent Application Publication
(10) Pub. No.: US 2026/0073007 A1
(43) Pub. Date: Mar. 12, 2026

(54) NEURAL PROCESSORS SUPPORTING WINOGRAD CONVOLUTIONS

(71) Applicant: APPLE INC., Cupertino, CA (US)

(72) Inventor: Lei WANG, San Carlos, CA (US)

(73) Assignee: APPLE INC., Cupertino, CA (US)

(21) Appl. No.: 18/827,814

(22) Filed: Sep. 8, 2024

(51) Int. Cl. G06F 17/15; G06F 7/523

(52) U.S. Cl. CPC G06F 17/15; G06F 7/523

(57) ABSTRACT

Embodiments relate to a neural processor circuit that includes a data storage device storing input data and a neural engine circuit. The input data can include a sequence of input parameters including a first group of input parameters for a first convolution and a second group of input parameters for a second convolution. The first convolution can be between the first group of input parameters and a number of convolutional kernel parameters, and the second convolution can be between the second group of input parameters and the number of convolutional kernel parameters. A kernel transformation circuit can receive the number of convolutional kernel parameters and generate a number of intermediate kernel parameters. Based on the intermediate kernel parameters, a first accumulator can generate a first convolution value of the first convolution, and a second accumulator can generate in parallel a second convolution value of the second convolution.

### BACKGROUND

### Field of the Disclosure

The present disclosure relates to circuits and systems including neural processors used in neural networks for performing convolutions and, more specifically, to support Winograd convolutions or convolutions based on a Winograd transform.

### Description of the Related Arts

An artificial neural network (ANN) is a computing system or model that uses a collection of connected nodes, such as neural processor circuits or neural processors, to process input data. An ANN can be organized into layers where different layers perform different types of transformation on their input data. Extensions or variants of ANN can include convolution neural networks (CNN), recurrent neural networks (RNN), deep belief networks (DBN), and other neural networks. These neural networks can involve extensive computing operations, including multiplication and accumulation. For example, CNN is a class of machine learning technique that can use convolution between input data and kernel data, which can be decomposed into multiplication and accumulation operations. Neural networks can be further applied in image data processing. Image data captured by an image sensor or received from other data sources can be processed in an image processing pipeline using various neural networks. Image processing operations can involve convolutions between input data and kernel data. Different kernels may be used to, for example, blur, sharpen, emboss or perform edge detect in the image, based on various convolutions.

Neural networks can be implemented in various ways. For example, neural networks can be implemented using a central processing unit (CPU) and its main memory. However, relying solely on the CPU for various operations of these neural networks can consume significant CPU bandwidth as well as increase the overall power consumption.

### SUMMARY

Embodiments relate to a neural processor circuit that includes a data storage device configured to store input data and a neural engine circuit. The input data can include a sequence of input parameters including a first group of input parameters for a first convolution and a second group of input parameters for a second convolution. The first convolution can be between the first group of input parameters and a number of convolutional kernel parameters, and the second convolution can be between the second group of input parameters and the number of convolutional kernel parameters. The neural engine circuit includes a kernel transformation circuit configured to receive the number of convolutional kernel parameters from a system memory and to generate a number of intermediate kernel parameters. The neural engine circuit further includes multipliers corresponding to the number of intermediate kernel parameters. A multiplier can be configured to multiply an intermediate kernel parameter by an intermediate input parameter generated based on the first group of input parameters and the second group of input parameters. In addition, the neural engine circuit can further include a first accumulator and a second accumulator, where the first accumulator can generate a first convolution value of the first convolution, and the second accumulator can generate a second convolution value of the second convolution, where the first convolution value and the second convolution value are generated in parallel.

### BRIEF DESCRIPTION OF THE DRAWINGS

FIG. 1 is a high-level diagram of an electronic device, according to some embodiments.

FIG. 2 is a block diagram illustrating components in the electronic device, according to some embodiments.

FIG. 3A is a block diagram illustrating image processing pipelines, according to some embodiments.

FIG. 3B is a block diagram illustrating a neural processor circuit, according to some embodiments.

FIG. 3C is a block diagram illustrating a neural processor circuit for performing convolutions on input data, according to some embodiments.

FIG. 4A is a block diagram illustrating a neural engine, according to some embodiments.

FIG. 4B is another block diagram illustrating a neural engine, according to some embodiments.

FIG. 5 is a conceptual diagram illustrating loops for processing input data at a neural processor circuit, according to some embodiments.

FIG. 6 is a conceptual diagram illustrating segmenting input data into slices, tiles, and work units, according to some embodiments.

FIG. 7 is a diagram illustrating programming of rasterizers in components of the neural processor circuit, according to some embodiments.

FIG. 8A is a block diagram illustrating a neural engine for performing convolutions, according to some embodiments.

FIG. 8B is a block diagram illustrating a neural processor circuit including a neural engine for performing convolutions, according to some embodiments.

FIG. 9A is a diagram illustrating computing multiple convolutions by a neural engine and a neutral processing circuit, according to some embodiments.

FIG. 9B is a diagram illustrating computing multiple convolutions by a neural engine and a neutral processing circuit, according to some embodiments.

FIG. 10 is a flowchart illustrating a method for computing multiple convolutions, according to some embodiments.

FIGS. 11A-11C are diagrams illustrating multiple pairs of convolutions computed by neural engines or neutral processing circuits in two phases in a pipelined manner, according to some embodiments.

FIG. 12 is a diagram illustrating an input transformer configured to generate intermediate input parameters for multiple pairs of convolutions computed in two phases in a pipelined manner, according to some embodiments.

FIGS. 13A-13C are diagrams illustrating two-stage operations of an input transformer and a kernel transformer configured to generate intermediate input parameters and intermediate kernel parameters in two stages, according to some embodiments.

FIGS. 14A-14B are diagrams illustrating multiple pairs of convolutions computed by two-stage input transformers in a pipelined manner, according to some embodiments.

FIG. 15 is an illustration of an example computer system for implementing some embodiments or portion(s) thereof of the disclosure provided herein, according to some embodiments.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a neural processor circuit for performing neural network operations, such as Winograd convolutions or convolutions based on a Winograd transform. The neural processor circuit can include multiple neural engines (NEs), where each neural engine includes circuits or devices related to convolutions based on a Winograd transform. A neural processor circuit can be referred to as a “neural processor” as well, and a NE can be referred to as a “neural engine circuit.”

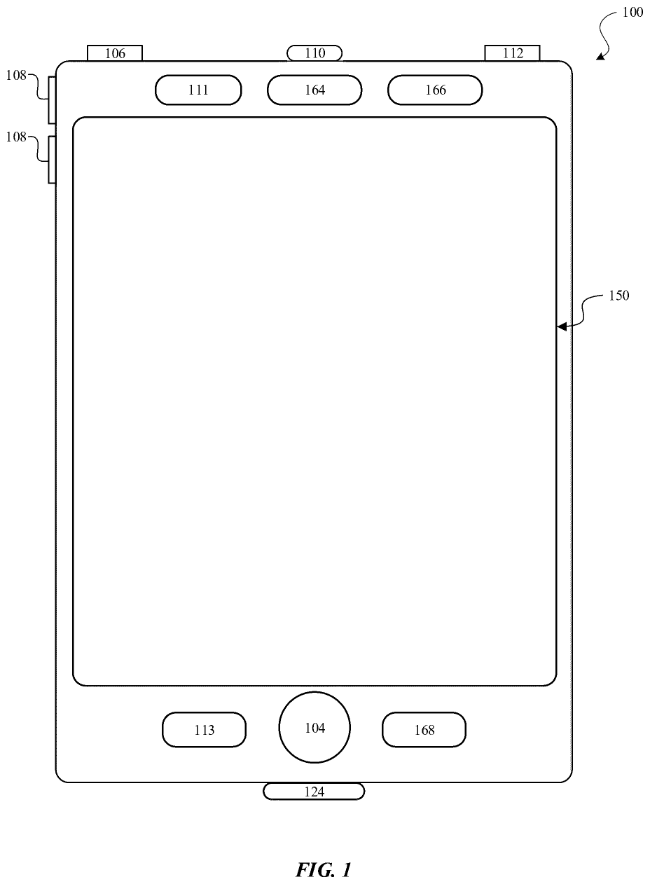

Embodiments of electronic devices, user interfaces for such devices, and associated processes for using such devices are described. In some embodiments, the device can be a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, Calif. Other portable electronic devices, such as wearables, laptops or tablet computers, are optionally used. In some embodiments, the device is not a portable communications device, but is a desktop computer or other computing device that is not designed for portable use. In some embodiments, the disclosed electronic device may include a touch sensitive surface (e.g., a touch screen display and/or a touch pad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. The device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. The device 100 may include components not shown in FIG. 1.

Device 100 is an example of an electronic device, and device 100 may have more or fewer components than listed above, some of which may be combined into a components or have a different configuration or arrangement. The various components of device 100 listed above are embodied in hardware, software, firmware or a combination thereof, including one or more signal processing and/or application specific integrated circuits (ASICs).

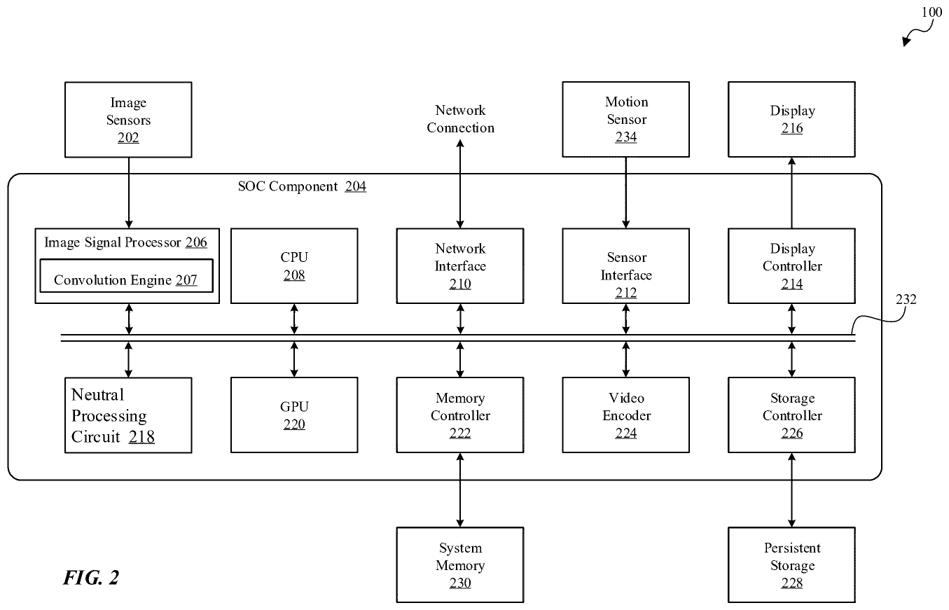

FIG. 2 is a block diagram illustrating components in device 100, according to some embodiments. Device 100 may perform various operations including image processing. For this and other purposes, the device 100 may include, among other components, image sensor 202, system-on-a chip (SOC) component 204, system memory 230, persistent storage (e.g., flash memory) 228, orientation sensor or motion sensor 234, and display 216. The components as illustrated in FIG. 2 are merely illustrative. For example, device 100 may include other components (such as speaker or microphone) that are not illustrated in FIG. 2. Further, some components (such as orientation sensor 234) may be omitted from device 100.

Image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern (hereinafter also referred to as “Bayer pattern”).

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory or other non-volatile random access memory devices.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

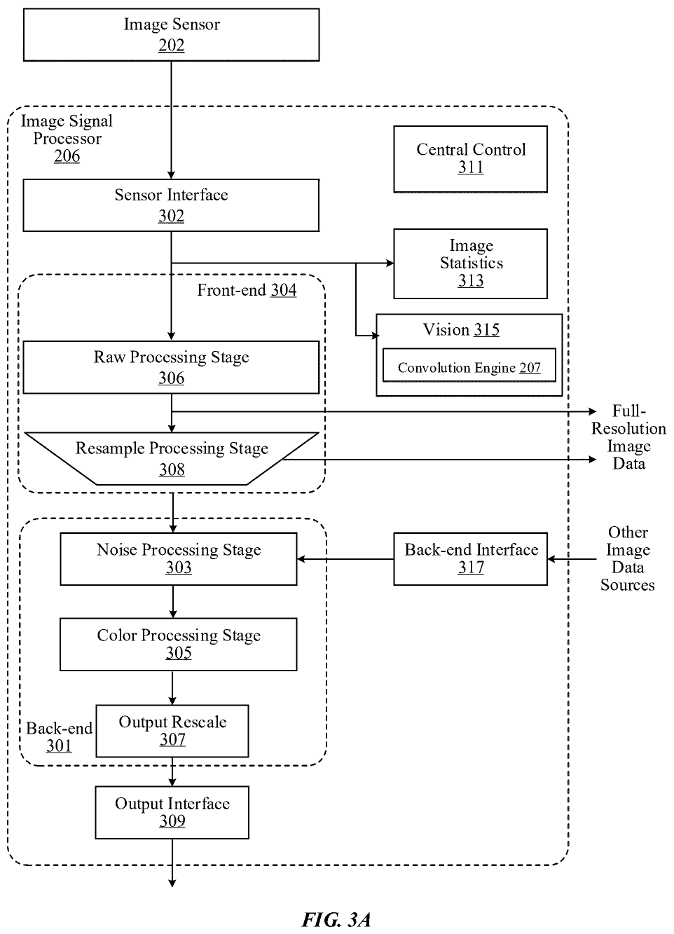

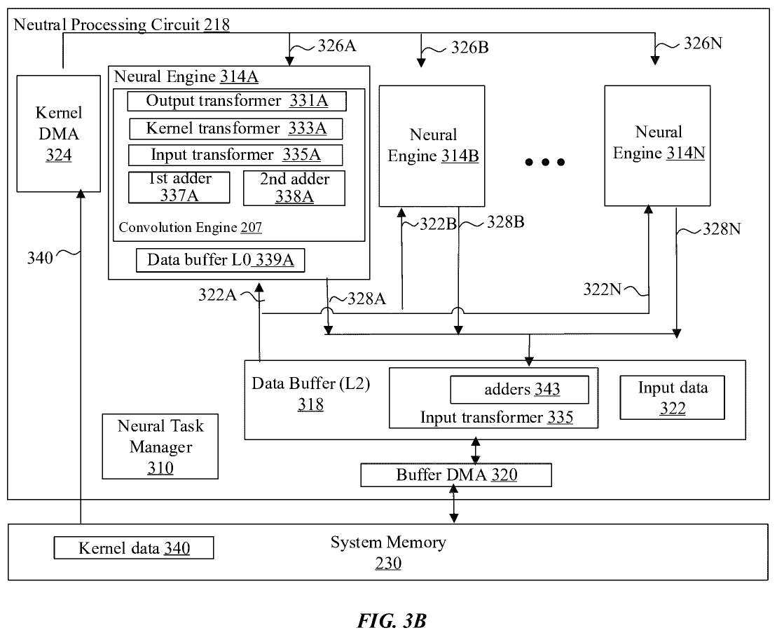

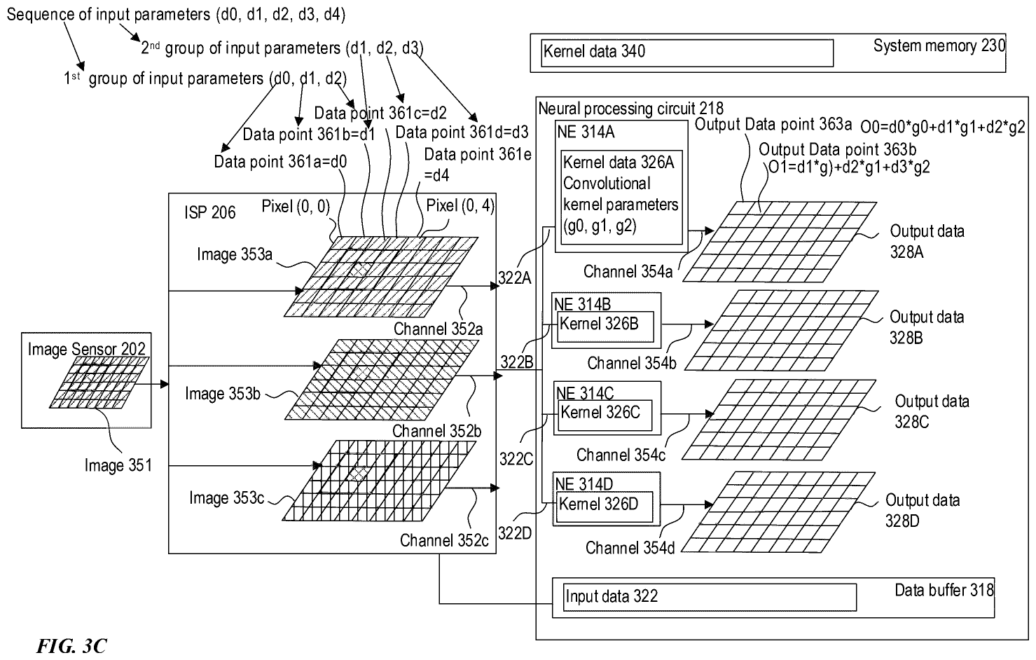

ISP 206 is hardware that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations, as described below in detail with reference to FIG. 3A.

In some embodiments, ISP 206 can include a convolution engine 207 that performs convolution operations or convolutions on raw image data from image sensor 202 or other processed data generated based on raw image data from image sensor 202. For this purpose, convolution engine 207 can include components for storing convolution kernel data, for performing calculations such as multiplications and for accumulating the multiplied values to generate an output, which are described in more detail below. Convolution engine 207 may perform various types of operations on the multi-channel image data, such as convolution operations, inter-channel processing operations, and per-channel processing operations. Example convolution operations may include generating edge maps or smoothed images. For example, an image convolved with a Gaussian kernel may produce a smooth image with reduced noise and aliasing. In another example, convolution engine 207 generates image features, such as Gabor features for classification when an image is convolved with a set of multiple directional convolution kernels. Further, in some embodiments, convolution engine 207 facilitates template matching for deep machine learning classification tasks, such as person or object detection. In some embodiments, convolutions for different purposes can have different kernel data.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

Neural processor circuit 218 is a circuit that performs various machine learning operations based on computations including multiplication, adding and accumulation. Such computations may be arranged to perform, for example, convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 302, the image signal processor 206, system memory 230 or other sources, such as network interface 210 or GPU 220. The output of neural processor circuit 218 may be provided to various components of device 100 such as the image signal processor 206, system memory 230 or CPU 208 for various operations. The structure and operation of neural processor circuit 218 is described below in detail with reference to FIG. 3B.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of the device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Storage controller 226 is circuitry for communicating with persistent storage 228. Storage controller 226 may read data from persistent storage 228 for processing by ISP 206, CPU 208, GPU 220 or other subcomponents of SOC component 204. Storage controller 226 may also write data to persistent storage 228 received from various subcomponents of SOC component 204.

Video encoder 224 is hardware, software, firmware or a combination thereof for encoding video data into a format suitable for storing in persistent storage 128 or for passing the data to network interface 210 for transmission over a network to another device.

In some embodiments, one or more subcomponents of SOC component 204 or some functionality of these subcomponents may be performed by software components executed on ISP 206, CPU 208 or GPU 220. Such software components may be stored in system memory 230, persistent storage 228 or another device communicating with device 100 via network interface 210.

Image data or video data may flow through various data paths within SOC component 204. In one example, raw image data may be generated from the image sensor 202 and processed by ISP 206, and then sent to system memory 230 via bus 232 and memory controller 222. After the image data is stored in system memory 230, it may be accessed by video encoder 224 for encoding or by display 116 for displaying via bus 232. Example Image Signal Processing Pipelines

FIG. 3A is a block diagram illustrating image processing pipelines implemented using ISP 206, according to some embodiments. In some embodiments, ISP 206 is coupled to image sensor 202 to receive raw image data. ISP 206 implements an image processing pipeline which may include a set of stages that process image information from creation, capture or receipt to output. ISP 206 may include, among other components, sensor interface 302, central control 311, front-end pipeline stages 304, back-end pipeline stages 301, image statistics module 313, vision module 315, back-end interface 317, and output interface 309. ISP 206 may include other components not illustrated in FIG. 3A or may omit one or more components illustrated in FIG. 3A.

In some embodiments, different components of ISP 206 process image data at different rates. In some embodiments, front-end pipeline stages 304 (e.g., raw processing stage 306 and resample processing stage 308) may process image data at an initial rate. Thus, the various different techniques, adjustments, modifications, or other processing operations performed by these front-end pipeline stages 304 at the initial rate. For example, if the front-end pipeline stages 304 process 2 pixels per clock cycle, then raw processing stage 308 operations (e.g., black level compensation, highlight recovery and defective pixel correction) may process 2 pixels of image data at a time. In contrast, one or more back-end pipeline stages 301 may process image data at a different rate less than the initial data rate. For example, back-end pipeline stages 301 (e.g., noise processing stage 303, color processing stage 305, and output rescale 307) may be processed at a reduced rate (e.g., 1 pixel per clock cycle). In some embodiments, back-end pipeline stages 301 may process image data at the initial data rate or at a different rate than the initial data rate.

Sensor interface 302 receives raw image data from image sensor 202 and processes the raw image data into image data processable by other stages in the pipeline. Sensor interface 302 may perform various preprocessing operations, such as image cropping, binning or scaling to reduce image data size. In some embodiments, pixels are sent from the image sensor 202 to sensor interface 302 in raster order (e.g., horizontally, line by line). The subsequent processes in the pipeline may also be performed in raster order and the result may also be output in raster order. Although a single image sensor 202 and a single sensor interface 302 are illustrated in FIG. 3A, when more than one image sensor is provided in device 100, a corresponding number of sensor interfaces may be provided in ISP 206 to process raw image data from each image sensor.

Front-end pipeline stages 304 process image data in raw or full-color domains. Front-end pipeline stages 304 may include, but are not limited to, raw processing stage 306 and resample processing stage 308. A raw image data may be in Bayer raw format, for example. In Bayer raw image format, pixel data with values specific to a particular color (instead of all colors) is provided in each pixel. In an image capturing sensor, image data can be provided in a Bayer pattern. Raw processing stage 308 may process image data in a Bayer raw format.

The operations performed by raw processing stage 306 include, but are not limited, sensor linearization, black level compensation, fixed pattern noise reduction, defective pixel correction, raw noise filtering, lens shading correction, white balance gain, and highlight recovery. Sensor linearization refers to mapping non-linear image data to linear space for other processing. Black level compensation refers to providing digital gain, offset and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighbor pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in Bayer format). Components of ISP 206 may convert raw image data into image data in full-color domain, and thus, raw processing stage 308 may process image data in the full-color domain in addition to or instead of raw image data.

Resample processing stage 308 performs various operations to convert, resample, or scale image data received from raw processing stage 306. Operations performed by resample processing stage 308 may include, but not limited to, demosaic operation, per-pixel color correction operation, Gamma mapping operation, color space conversion and downscaling or sub-band splitting. Demosaic operation refers to converting or interpolating missing color samples from raw image data (e.g., in a Bayer pattern) to output image data into a full-color domain. Demosaic operation may include low pass directional filtering on the interpolated samples to obtain full-color pixels. Per-pixel color correction operation refers to a process of performing color correction on a per-pixel basis using information about relative noise standard deviations of each color channel to correct color without amplifying noise in the image data. Gamma mapping refers to converting image data from input image data values to output data values to perform special image effects, including black and white conversion, sepia tone conversion, negative conversion, or solarize conversion. For the purpose of Gamma mapping, lookup tables (or other structures that index pixel values to another value) for different color components or channels of each pixel (e.g., a separate lookup table for Y, Cb, and Cr color components) may be used. Color space conversion refers to converting color space of an input image data into a different format. In some embodiments, resample processing stage 308 converts RBD format into YCbCr format for further processing.

Central control 311 may control and coordinate overall operation of other components in ISP 206. Central control 311 performs operations including, but not limited to, monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control 311 may update programmable parameters for other components in ISP 206 while the other components are in an idle state. After updating the programmable parameters, central control 311 may place these components of ISP 206 into a run state to perform one or more operations or tasks. Central control 311 may also instruct other components of ISP 206 to store image data (e.g., by writing to system memory 230 in FIG. 2) before, during, or after resample processing stage 308. In this way full-resolution image data in raw or full-color domain format may be stored in addition to or instead of processing the image data output from resample processing stage 308 through backend pipeline stages 301.

Image statistics module 313 performs various operations to collect statistic information associated with the image data. The operations for collecting statistics information may include, but not limited to, sensor linearization, mask patterned defective pixels, sub-sample raw image data, detect and replace non-patterned defective pixels, black level compensation, lens shading correction, and inverse black level compensation. After performing one or more of such operations, statistics information such as 3A statistics (Auto white balance (AWB), auto exposure (AE), auto focus (AF)), histograms (e.g., 2D color or component) and any other image data information may be collected or tracked. In some embodiments, certain pixels' values, or areas of pixel values may be excluded from collections of certain statistics data (e.g., AF statistics) when preceding operations identify clipped pixels. Although a single statistics module 313 is illustrated in FIG. 3A, multiple image statistics modules may be included in ISP 206. In some embodiments, each statistic module may be programmed by central control 311 to collect different information for the same or different image data.

Vision module 315 performs various operations to facilitate computer vision operations at CPU 208 such as facial detection in image data. The vision module 315 may perform various operations including pre-processing, global tone-mapping and Gamma correction, vision noise filtering, resizing, keypoint detection, convolution and generation of histogram-of-orientation gradients (HOG). The pre-processing may include subsampling or binning operation and computation of luminance if the input image data is not in YCrCb format. Global mapping and Gamma correction can be performed on the pre-processed data on a luminance image. Vision noise filtering is performed to remove pixel defects and reduce noise present in the image data to improve the quality and performance of subsequent computer vision algorithms. Such vision noise filtering may include detecting and fixing dots or defective pixels and performing bilateral filtering to reduce noise by averaging neighbor pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing cameral pose and object tracking. Keypoint detection refers to the process of identifying such keypoints in an image. Convolution may be used in image/video processing and machine vision. Convolution may be performed, for example, to generate edge maps of images or smoothen images. HOG provides descriptions of image patches for tasks in image analysis and computer vision. HOG can be generated, for example, by (i) computing horizontal and vertical gradients using a difference filter, (ii) computing gradient orientations and magnitudes from the horizontal and vertical gradients, and (iii) binning the gradient orientations.

In some embodiments, convolution engine 207 can be implemented within vision module 315 or other components of ISP 206 to perform convolution operations on raw image data from image sensor 202 or other processed data generated based on raw image data from image sensor 202. For this purpose, convolution engine 207 can include components for storing convolution kernel data, for performing calculation such as multiplications, and for accumulating the multiplied values to generate an output, which are described in more detail below. In some embodiments, operations of convolution engine 207 can be implemented by neutral processing circuit 218 individually or in coordination with ISP 206.

Back-end interface 317 receives image data from other image sources than image sensor 202 and forwards it to other components of ISP 206 for processing. For example, image data may be received over a network connection and be stored in system memory 230. Back-end interface 317 retrieves the image data stored in system memory 230 and provide it to back-end pipeline stages 301 for processing. One of many operations that are performed by back-end interface 317 is converting the retrieved image data to a format that can be utilized by back-end processing stages 301. For instance, back-end interface 317 may convert RGB, YCbCr 4:2:0, or YCbCr 4:2:2 formatted image data into YCbCr 4:4:4 color format.

Back-end pipeline stages 301 processes image data according to a particular full-color format (e.g., YCbCr 4:4:4 or RGB). In some embodiments, components of the back-end pipeline stages 301 may convert image data to a particular full-color format before further processing. Back-end pipeline stages 301 may include, among other stages, noise processing stage 303 and color processing stage 305. Back-end pipeline stages 301 may include other stages not illustrated in FIG. 3A.

Noise processing stage 303 performs various operations to reduce noise in the image data. The operations performed by noise processing stage 303 include, but are not limited to, color space conversion, gamma/de-gamma mapping, temporal filtering, noise filtering, luma sharpening, and chroma noise reduction. The color space conversion may convert an image data from one color space format to another color space format (e.g., RGB format converted to YCbCr format). Gamma/de-gamma operation converts image data from input image data values to output data values to perform special image effects. Temporal filtering filters noise using a previously filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (e.g., no color). In some embodiments, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In some embodiments, spatial noise filtering may not be included as part of the temporal loop for temporal filtering (e.g., the spatial noise filter may be applied to an image frame after it is stored as a reference image frame (and thus is not a spatially filtered reference frame).

Color processing stage 305 may perform various operations associated with adjusting color information in the image data. The operations performed in color processing stage 305 include, but are not limited to, local tone mapping, gain/offset/clip, color correction, three-dimensional color lookup, gamma conversion, and color space conversion. Local tone mapping refers to spatially varying local tone curves in order to provide more control when rendering an image. For instance, a two-dimensional grid of tone curves (which may be programmed by the central control 311) may be bi-linearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 305 to perform other special image effects, including black and white conversion, sepia tone conversion, negative conversion, or solarize conversion.

Output rescale module 307 may resample, transform and correct distortion on the fly as the ISP 206 processes image data. Output rescale module 307 may compute a fractional input coordinate for each pixel and use this fractional coordinate to interpolate an output pixel via a polyphase resampling filter. A fractional input coordinate may be produced from a variety of possible transforms of an output coordinate, such as resizing or cropping an image (e.g., via a horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale module 307 may apply transforms to image data as it is processed at output rescale module 307. Output rescale module 307 may include horizontal and vertical scaling components. The vertical portion of the design may implement series of image data line buffers to hold the “support” needed by the vertical filter. As ISP 206 may be a streaming device, it may be that only the lines of image data in a finite-length sliding window of lines are available for the filter to use. Once a line has been discarded to make room for a new incoming line, the line may be unavailable. Output rescale module 307 may statistically monitor computed input Y coordinates over previous lines and use it to compute an optimal set of lines to hold in the vertical support window. For each subsequent line, output rescale module 307 may automatically generate a guess as to the center of the vertical support window. In some embodiments, output rescale module 307 may implement a table of piecewise perspective transforms encoded as digital difference analyzer (DDA) steppers to perform a per-pixel perspective transformation between a input image data and output image data in order to correct artifacts and motion caused by sensor motion during the capture of the image frame. Output rescale may provide image data via output interface 307 to various other components of system 100, as discussed above with regard to FIGS. 1 and 2.

In some embodiments, the functionally of components 301 through 317 may be performed in a different order than the order implied by the order of these functional units in the image processing pipeline illustrated in FIG. 3A, or may be performed by different functional components than those illustrated in FIG. 3A. Moreover, the various components as described in FIG. 3A may be embodied in various combinations of hardware, firmware or software.

FIG. 3B illustrates neural processor circuit 218, according to some embodiments. Neural processor circuit 218 is a configurable circuit that performs neural network operations on input data 322 stored in data buffer 318 based at least on kernel data 340 stored in system memory 230. For this purpose, neural processor circuit 218 may include, among other components, neural task manager 310, neural engines 314A through 314N (hereinafter collectively referred as “neural engines 314” and individually also referred to as “neural engine 314”), kernel direct memory access (DMA) 324, data buffer 318 and buffer DMA 320. Neural processor circuit 218 may include other components not illustrated in FIG. 3B.

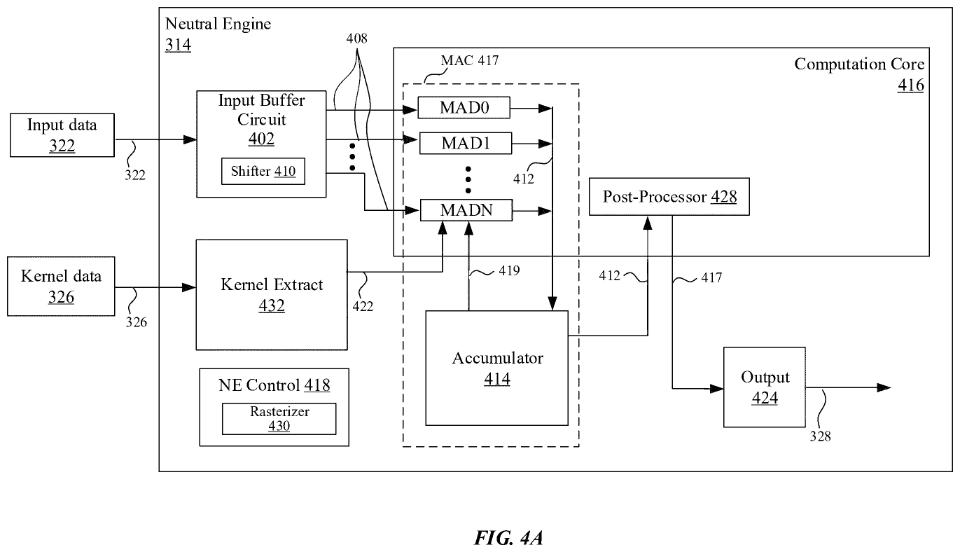

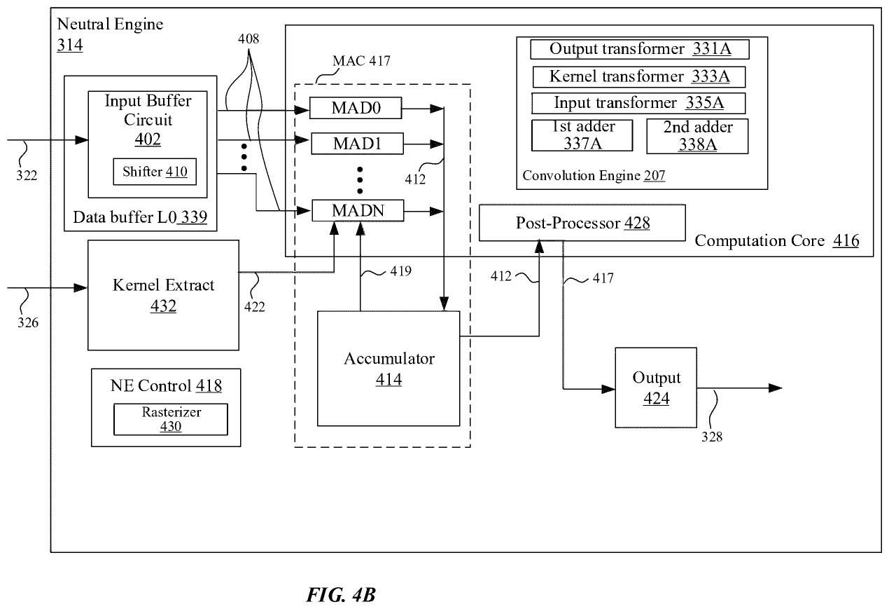

Each of neural engines 314 performs computing operations for neural network operations in parallel, according to some embodiments. Depending on the load of an operation, an entire set of neural engines 314 may be operated or a subset of neural engines 314 may be operated while the remaining neural engines 314 are placed in a power save mode. Each of neural engines 314 includes components for storing one or more kernels, for performing multiply-accumulate operations, and for post processing to generate an output data 328, as described below in detail with reference to FIGS. 4A and 4B. One example of a neural network operation is a convolution operation.

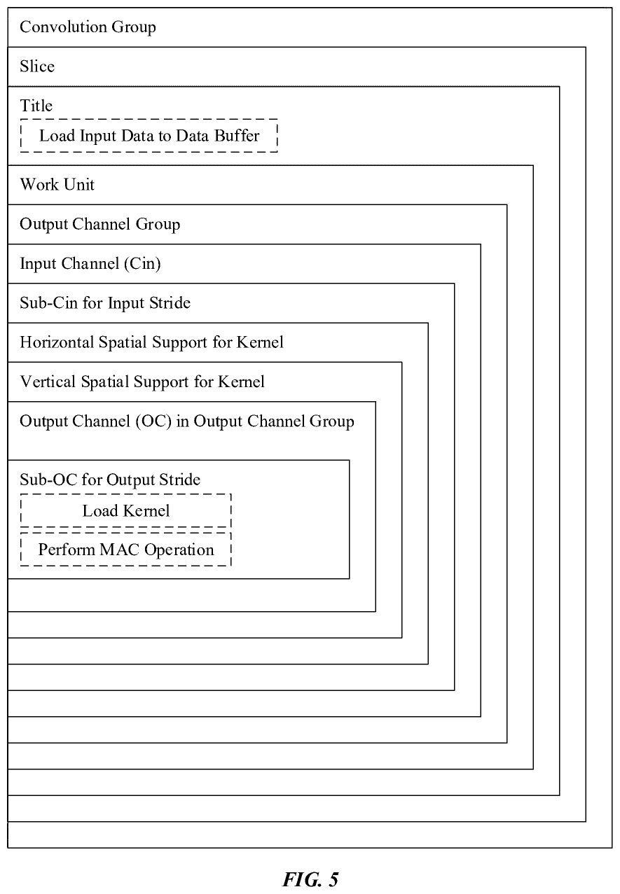

Neural task manager 310 manages the overall operation of neural processor circuit 218. Neural task manager 310 may receive a task list from a compiler executed by CPU 208, store tasks in its task queues, choose a task to perform, and send instructions to other components of neural processor circuit 218 for performing the chosen task. Neural task manager 310 may also perform switching of tasks on detection of events, such as receiving instructions from CPU 208. In some embodiments, neural task manager 310 sends rasterizer information to the components of neural processor circuit 218 to enable each of the components to track, retrieve or process appropriate portions of the input data and kernel data, as described below in detail with reference to FIGS. 5 through 7. Although neural task manager 310 is illustrated in FIG. 3B as part of neural processor circuit 218, neural task manager 310 may be a component outside neural processor circuit 218.

Kernel DMA 324 is a read circuit that fetches kernel data 340 from a source (e.g., system memory 230) and sends kernel data 326A through 326N to each of neural engines 314, where kernel data 326A through 326N can be the same or a processed version of kernel data 340. Kernel data represents information from which kernel elements or parameters can be extracted. In some embodiments, the kernel data may be in a compressed format which is decompressed at each of neural engines 314. Although kernel data provided to each of neural engines 314 may be the same in some instances, the kernel data provided to each of neural engines 314 is different in most instances, according to some embodiments.

Data buffer 318 is a temporary storage for storing data associated with the neural network operations. In some embodiments, data buffer 318 is embodied as a memory that can be accessed and shared by all of neural engines 314 including neural engine 314A through 314N. Data buffer 318 may store input data 322A through 322N for feeding to corresponding neural engines 314A through 314N, as well as output from each of neural engines 314A through 314N for feeding back into neural engines 314 or sending to a target circuit (e.g., system memory 230). Input data 322A through 322N can be a part or all of input data 322 stored in data buffer 318. The operations of data buffer 318 and other components of neural processor circuit 218 are coordinated so that the input data and intermediate data stored in data buffer 318 is reused across multiple operations at neural engines 314 to reduce data transfer to and from system memory 230. Data buffer 318 may be operated in a broadcast mode, where data input data of all input channels are fed to all neural engines 314 or in a unicast mode where data input data of a subset of input channels are fed to each neural engine 314, according to some embodiments.

In some embodiments, input data 322 stored in data buffer 318 may be part of, among others, image data, histogram of oriented gradients (HOG) data, audio data, meta data, output data 328 of a previous cycle of neural engine 314, and other processed data received from other components of SOC component 204. In some embodiments, input data 322 includes pixel values of an image. In some embodiments, input data 322 can be other types of data (e.g., HOG data) suitable for a convolution operation. In some embodiments, input data 322 can include a stream of input values or a stream of values, such as a sequence, a group, a set, an array, or an ordered list of numbers, where each element or parameter of the array or the ordered list includes a number representing a value for a pixel of an image. A basic unit of input data 322 can be referred to as an “input element” or an “input parameter,” which can be a number representing a value for a pixel of an image.

In some embodiments, neural engine 314A can include components for convolution engine 207, such as an input transformer 335A, kernel transformer 333A, output transformer 331A, which can perform operations for convolutions (e.g., convolutions based on a Winograd transform). In some embodiments, input transformer 335A can be an input transformation circuit to perform input transformation operations. Similarly, kernel transformer 333A can be a kernel transformation circuit to perform kernel transformation; while output transformer 331A can be an output transformation circuit to perform output transformation. In some embodiments, input transformer 335A can be implemented within data buffer 318 to become an input transformer 335. In some embodiments, input transformer 335 can include one or more floating point adders 343. When input transformer 335 is implemented within data buffer 318, the operation results generated by input transformer 335 can be shared by multiple NEs, such as NE 314A, . . . NE 314N.

In addition, neural engine 314A can include a number of adders, such as a first adder 337A, a second adder 338A, and a data buffer 339A. Data buffer 339A can store data local to neural engine 314A. In some embodiments, data buffer 339A inside neural engine 314A is separated from data buffer 318 external to neural engine 314A. Data stored in data buffer 318 can be shared by multiple neural engines, such as neural engine 314A through 314N, while data stored in data buffer 339A is only accessible by neural engine 314A and not by other neural engines, according to some embodiments.

In some embodiments, neural engine 314A can perform operations for numbers in different representations. For example, input data 322 can include parameters that are numbers represented by 8-bit signed or unsigned numbers, 16-bit floating point numbers, or other number representations. In some embodiments, first adder 337A can be an 8-bit signed adder or unsigned adder, while second adder 338A can be a 16-bit floating point adder.

In some embodiments, neural engine 314B through neural engine 314N can have a similar structure or implementation as neural engine 314A. In some embodiments, neural engine 314B through neural engine 314N can have more components or fewer components than those shown for neural engine 314A.

Buffer DMA 320 includes a read circuit that receives a portion (e.g., tile) of the input data from a source (e.g., system memory 230) for storing in data buffer 318 and includes a write circuit that forwards data from data buffer 138 to a target (e.g., system memory).

In some embodiments, FIG. 3C is a conceptual diagram illustrating inputs and outputs data being processed by neural engines, such as neural engine 314A, according to some embodiments. Neural engines, such as neural engine 314A, can perform convolutions or other operations on multi-channel input data and generate multi-channel output data. The number of input and output channels can be different. In some embodiments, there can be three input channels (e.g., channel 352a, channel 352b, and channel 352c) and four output channels (e.g., channel 354a, channel 354b, channel 354c, and channel 354d). Image sensor 202 can capture or generate an image 351, which can be processed by ISP 206 to generate 3 images including image 353a, image 353b, and image 353c to be transmitted over the 3 channels, one image per channel. In some embodiments, the 3 input channels (e.g., channel 352a, channel 352b, and channel 352c) can include RGB color channels or YCbCr color channels, where image 353a, image 353b, and image 353c are 3 images generated for the corresponding channels by ISP 206. In some embodiments, there can be more than 3 channels or fewer than 3 channels.

In some embodiments, input data on each input channel 352a, channel 352b, and channel 352c can be transmitted to neural processing circuit 208 to become input data 322, which can be provided to one or more NEs, such as NE 314A, NE 314B, NE 314C, and NE 314D. In some embodiments, input data 322A can be provided to NE 314A to be processed and perform operations with kernel data 326A to generate output data 328A, which can be an image. Similarly, input data 322B can be provided to NE 314B to be processed and perform operations with kernel data 326B to generate output data 328B, which can be an image; while input data 322C can be provided to NE 314C to be processed and perform operations with kernel data 326C to generate output data 328C, which can be an image. Moreover, input data 322D can be provided to NE 314D to be processed and perform operations with kernel data 326D to generate output data 328D, which can be an image.

In some embodiments, input data 322A, input data 322B, input data 322C, and input data 322D can be a subset of input data 322 or a subset of image 353a, image 353b, and image 353c provided from the 3 input channels. In some embodiments, input data 322A, input data 322B, input data 322C, and input data 322D can be the same or different from one another. In some embodiments, kernel data 326A, kernel data 326B, kernel data 326C, and kernel data 326D can be the same as each other or different from each other. There can be various configurations for NE 314A, NE 314B, NE 314C, or NE 314D.

In some embodiments, input data 322A can include a sequence of input parameters (d₀, d₁, d₂, d₃, d₄), which can correspond to a numeric value of a sequence of pixels in a row of image 353a. For example, input parameter d₀ is a value or a number of data point 361a, which is a pixel at the coordinate (0,0); input parameter d₁ is a value of data point 361b, which is a pixel at the coordinate (0,1); input parameter d₂ is a value of data point 361c, which is a pixel at the coordinate (0,2); input parameter d₃ is a value of data point 361d, which is a pixel at the coordinate (0,3); and input parameter d₄ is a value of data point 361e, which is a pixel at the coordinate (0,4). In some embodiments, input data 322A can include a sequence of input parameters representing values of data points, which are pixels in adjacent positions of an image, e.g., image 353a.

In some embodiments, a sequence of input parameters can have a length. For example, a sequence of input parameters (d₀, d₁, d₂, d₃) can have a length of 4, while a sequence of input parameters (d₀, d₁, d₂, d₃, d₄) can have a length of 5. In some embodiments, sequence of input parameters (d₀, d₁, d₂, d₃) can include a first group of input parameters (d₀, d₁, d₂), and a second group of input parameters (d₁, d₂, d₃). The first group of input parameters (d₀, d₁, d₂) can be used for a first convolution, and the second group of input parameters (d₁, d₂, d₃) can be used for a second convolution. The first group of input parameters (d₀, d₁, d₂) includes a single input parameter d₀ that is not included in the second group of input parameters (d₁, d₂, d₃). In addition, the first group of input parameters (d₀, d₁, d₂) and the second group of input parameters (d₁, d₂, d₃) share multiple common input parameters, such as input parameters (d₁, d₂).

In some embodiments, the first group of input parameters (d₀, d₁, d₂) can be used for the first convolution associated with a first data point 361a, which can be the pixel at the coordinate (0,0) of image 353a, while the second group of input parameters (d₁, d₂, d₃) can be used for the first convolution associated with a second data point 361b, which can be the pixel at the coordinate (0,1) of image 353a. Accordingly, the first data point 361a representing a pixel at (0,0) of image 353a and the second data point 361b representing a pixel at (0,1) of image 353a are adjacent to each other in a row of image 353a.

In some embodiments, kernel data 326A can include 3 kernel parameters (g₀, g₁, g₂), which can be referred to as “convolutional kernel parameters.” In some embodiments, (g₀, g₁, g₂) is a 1*3 matrix. In some embodiments, an output data point 363a can have a convolution value of the first convolution between the first group of input parameters (d₀, d₁, d₂) and convolutional kernel parameters (g₀, g₁, g₂), which can be defined by o₀=d₀·g₀+d₁·g₁+d₂·g₂. In some embodiments, o₀ can represent the value of output data point 363a representing a pixel at (0,0) of output data 328A. The first convolution between the first group of input parameters (d₀, d₁, d₂) and convolutional kernel parameters (g₀, g₁, g₂) can be a convolution between data point 361a and kernel data 326A. Similarly, an output data point 363b can have a convolution value of the second convolution between the second group of input parameters (d₁, d₂, d₃) and convolutional kernel parameters (g₀, g₁, g₂), which can be defined by o₁=d₁·g₀+d₂·g₁+d₃·g₂.

In some embodiments, the first convolution o₀=d₀·g₀+d₁·g₁+d₂·g₂ and the second convolution o₁=d₁·g₀+d₂·g₁+d₃·g₂ can be performed by circuits or devices in FIGS. 4A and 4B shown below.

FIG. 4A is a block diagram of neural engine (NE) 314, according to some embodiments. In some embodiments, neural engine 314 can be an example of neural engine 314A, 314B, . . . , or 314N. Neural engine 314 performs various operations to facilitate neural network operations such as convolution, spatial pooling and local response normalization. Neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or multiple channels as shown in FIG. 3C. In some embodiments, neural engine 314 can perform the first convolution o₀=d₀·g₀+d₁·g₁+d₂·g₂ and the second convolution o₁=d₁·g₀+d₂·g₁+d₃·g₂ one at a time in sequence.

Neural engine 314 may include, among other components, input buffer circuit 402, computation core 416, neural engine control 418, kernel extract circuit 432, accumulators 414 and output circuit 424. Neural engine 314 may include further components not illustrated in FIG. 4A.

Input buffer circuit 402 is a circuit that stores a portion of input data 322 as it is received from data buffer 318 and sends an appropriate portion 408 of input data for a current task or process loop to computation core 416 for processing. Input buffer circuit 402 includes a shifter 410 that shifts read locations of input buffer circuit 402 to change portion 408 of input data sent to computation core 416. By changing portions of input data provided to computation core 416 via shifting, neural engine 314 can perform multiply-accumulate for different portions of input data based on fewer number of read operations. In some embodiments, the input data 322 includes data of different convolution groups and/or input channels.

Kernel extract circuit 432 is a circuit that receives kernel data 326 from kernel DMA 324 and extracts kernel coefficients 422, which can also be referred to as “kernel parameters.” In some embodiments, kernel extract circuit 432 references a look-up table (LUT) and uses a mask to reconstruct a kernel from compressed kernel data 326. The mask indicates locations in the reconstructed kernel to be padded with zero and remaining locations to be filled with numbers. Kernel coefficients 422 of the reconstructed kernel are sent to computation core 416 to populate a register in multiply-add (MAD) circuits of computation core 416. In some embodiments, kernel extract circuit 432 receives kernel data in an uncompressed format and the kernel coefficients are determined without referencing a LUT or using a mask.

Computation core 416 is a programmable circuit that performs computation operations. For this purpose, computation core 416 may include MAD circuits MAD0 through MADN and a post processor 428. Each of MAD circuits MAD0 through MADN may store an input value in portion 408 of the input data and a corresponding kernel coefficient in kernel coefficients 422. The input value and the corresponding kernel coefficient are multiplied in each of MAD circuits to generate a processed value 412.

Accumulator 414 is a memory circuit that receives and stores processed values 412 from MAD circuits. The processed values stored in accumulator 414 may be sent back as feedback information 419 for further multiply and add operations at MAD circuits or sent to post processor 428 for post processing. Accumulator 414 in combination with MAD circuits form a multiply-accumulator (MAC) 404. In some embodiments, accumulator 414 may have subunits, where each subunit sends data to different components of neural engine 314. For example, during a processing cycle, data stored in a first subunit of accumulator 414 is sent to MAC circuits, while data stored in a second subunit of accumulator 414 is sent to post processor 428.

Post processor 428 is a circuit that performs further processing of values 412 received from accumulator 414. The post processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from the post processor 428 as processed values 417 to output circuit 424.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAD circuits, and perform different types of post-processing operations at post processor 428. To configure components of neural engine 314 to operate in a desired manner, NE control 418 sends control signal to components of the neural engine. NE control 418 may also include rasterizer 430 that tracks the current task or process loop being processed at neural engine 314, as described below in detail with reference to FIGS. 5 through 7.

Output circuit 424 receives processed values 417 from post processor 428 and interfaces with data buffer 318 to store processed values 417 in data buffer 318. For this purpose, output circuit 424 may send out as output data 328 in a sequence or a format that is different from the sequence or format in which processed values 417 are processed in post processor 428.

The components in neural engine 314 may be configured during a configuration period by the NE control 418 and neural task manager 310. For this purpose, neural task manager 310 sends configuration information to neural engine 314 during a configuration period. The configurable parameters and modes may include, but are not limited to, mapping between input data parameters or elements and kernel parameters or elements, the number of input channels, the number of output channels, performing of output strides, and enabling/selection of post-processing operations at the post processor 428.

FIG. 4B is another block diagram of neural engine 314, according to some embodiments. In some embodiments, neural engine 314 can be an example of neural engine 314A, 314B, . . . , or 314N shown in FIGS. 3B and 3C. Neural engine 314 can perform various operations to facilitate neural network operations, such as convolution, spatial pooling, and local response normalization. Neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 can be of a single channel or multiple channels. In some embodiments, input data 322 can include a stream of input values or a stream of values, such as an array or ordered list of numbers, where each element of the array or the ordered list includes a number representing a value for a pixel of an image. In some embodiments, input data 322 can include a sequence of input parameters (d₀, d₁, d₂, d₃, d₄), which can correspond to the numeric value of a sequence of pixels in a row of image 353a. In some embodiments, sequence of input parameters (d₀, d₁, d₂, d₃) can include first group of input parameters (d₀, d₁, d₂) for a first convolution associated with first data point 361a and a second group of input parameters (d₁, d₂, d₃) for a second convolution associated with second data point 363b.

Neural engine 314 may include, among other components, input buffer circuit 402, computation core 416, neural engine control 418, kernel extract circuit 432, accumulators 414, and output circuit 424. Neural engine 314 may include further components not illustrated in FIG. 4B. Functions and structures of input buffer circuit 402, computation core 416, NE control 418, kernel extract circuit 432, accumulators 414, and output circuit 424 are similar to the functions and structures described in FIG. 4A.

In some embodiments, input buffer circuit 402 can be within data buffer 339, which is local to neural engine 314. In some embodiments, neural engine 314 can include components for convolution engine 207, such as an input transformer 335, kernel transformer 333, output transformer 331, which can perform operations for convolutions (e.g., convolutions based on a Winograd transform). In addition, neural engine 314 can include a number of adders, such as first adder 337, second adder 338, and data buffer 339. Data buffer 339 can store data local to neural engine 314.

In some embodiments, neural engine 314 can perform operations for numbers in different representations. For example, input data 322 can include numbers represented by 8-bit signed or unsigned numbers, 16-bit floating point numbers, or other number representations. In some embodiments, first adder 337 can be an 8-bit signed adder or unsigned adder, while second adder 338 can be a 16-bit floating point adder.

In some embodiments, input data 322 can include a stream of input values, a stream of values, a sequence of input parameters, such as an array or ordered list of numbers, where each element of the array or the ordered list includes a number or a parameter representing a value for a pixel of an image. Input data 322 can be split into smaller pieces of data, which can be smaller arrays or smaller ordered lists with shorter lengths, for parallel processing at multiple neural engines 314. Multiple cycles of operations can be performed to generate output for a task associated with a neural network. A compiler executed by CPU 208 analyzes the hierarchy and nodes of the neural network and determines how the input data is to be segmented based on the hardware constraints of neural processor circuit 218. One function of the compiler is to determine how input data is to be split into smaller data units for processing at neural engines 314, and how the processing is to be iterated in loops to produce the result for tasks.

FIG. 5 is a conceptual diagram illustrating loops for processing the input data at neural processor circuit 218, according to some embodiments. The outermost loop represents processing for a convolution group, if group convolution involving multiple convolution group is used. Group convolutions are convolutions where input data of the input channels in each group are used only for generating output data of output channels of each group but are not used for generating output data for output channels of other groups, according to some embodiments. Hence, each group of the group convolution can be treated as a separate convolution operation.

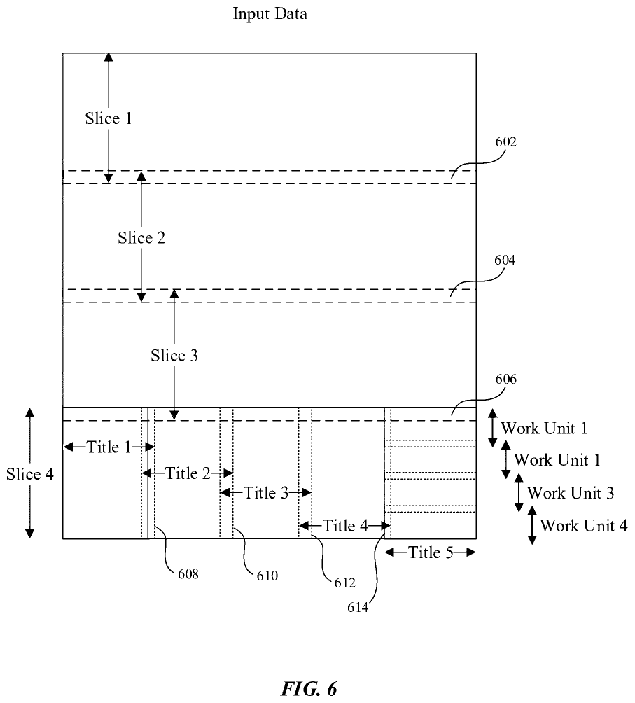

A processing loop for a slice of the input data is in the loop for each convolution group. The entire input data for a convolution operation is segmented into multiple strips of slices in an overlapping manner, as shown in FIG. 6. The overlapping portions 602, 604, 606 are parts of the input data that are over fetched in two adjacent slices to provide spatial support for a corresponding kernel. The second outermost loop performs a convolution operation for each slice in the input data. Within the loop for a slice is a processing loop for a tile of the slice. Each slice is segmented into tiles, as shown in FIG. 6. The overlapping portions 608, 610, 612, 614 are parts of the input data in slice 4 that are over fetched in two adjacent tiles to provide spatial support for a corresponding kernel. The rightmost tile can have a width smaller than other tiles of the slice. In some embodiments, input data for each tile is loaded onto data buffer 318 in a read cycle and reused for operations in processing loops for the tile. A processing loop for a work unit is in the processing loop for the tile. Each tile is segmented into multiple work units as shown in FIG. 6. A work unit is a portion of the input data having a size that produces output values that fit into accumulator 414 of neural engine 314 during a single cycle of computation core 416. Although the shape of each work unit is shown as a horizontal strip in FIG. 6, the shape of the work unit can be different depending on the shape and size of the tile. The work units also have overlapping parts that represent overfetched to provide support for a corresponding kernel. Work units for the last tile of a slice may have a shape of a vertical strip if the tile is tall. In some embodiments, the size of each work unit is 256 bytes. For example, work units can be shaped to one of 16×16, 32×8, 64×4, 128×2, or 256×1 dimension.

For each work unit, an internal processing loop may be provided for an output channel group (OCG). The number of output channels produced for a given work unit by a single cycle of computation core 416 is referred to as an “OCG.” Depending on operation modes, each neural engine 314 may process output data of different numbers of output channels (e.g., 8 channels, 32 channels) for a single load of input data into its input buffer circuit 402.

For each output channel group, an internal processing loop may be provided for an input channel (Cin). If an input stride is implemented to skip certain input data, loops for sub-input channels (Sub-Cin) may be provided within the processing loop for the input channel (Cin).

For each input channel or each sub-input channel, internal loops are provided for processing horizontal spatial support for a kernel and the vertical support within each horizontal spatial support. The spatial support refers to the input data for convolution with the kernel and includes overfetched input data for performing convolution at the edges of the input data.

Overfetch refers to fetching additional input data in a current slice, tile, or work unit so that a proper dimension of input data can be provided for convolution with a kernel. In some embodiments, overfetch is performed vertically between slices to obtain additional rows of input data (shown as overlapping portions 602, 604, 606 in FIG. 6), horizontally between tiles to obtain additional columns of input data (shown as overlapping portions 608, 606, 612, 614 in FIG. 6), and vertically between work units within a tile to obtain additional rows of input data.

For each spatial support for the kernel, an internal processing loop for an output channel (OC) is provided to generate output data for each output channel (Cout). In cases where an output stride implements a spatial upsampling, an additional inner loop for processing each sub-output channel is provided. Loading of kernel coefficients and MAC operations are performed within the loop for the output channel (OC) or sub-output channel if an output stride is implemented, to generate output data for the output channel (OC) or sub-output channel.

The nested loop structure of FIG. 5 is merely illustrative. Loops may be omitted, added or structured differently depending on various factors. For example, if only a single convolution group is used, the outermost loop may be removed. Further, the loop structure for the horizontal spatial support and the vertical spatial support may be reversed.

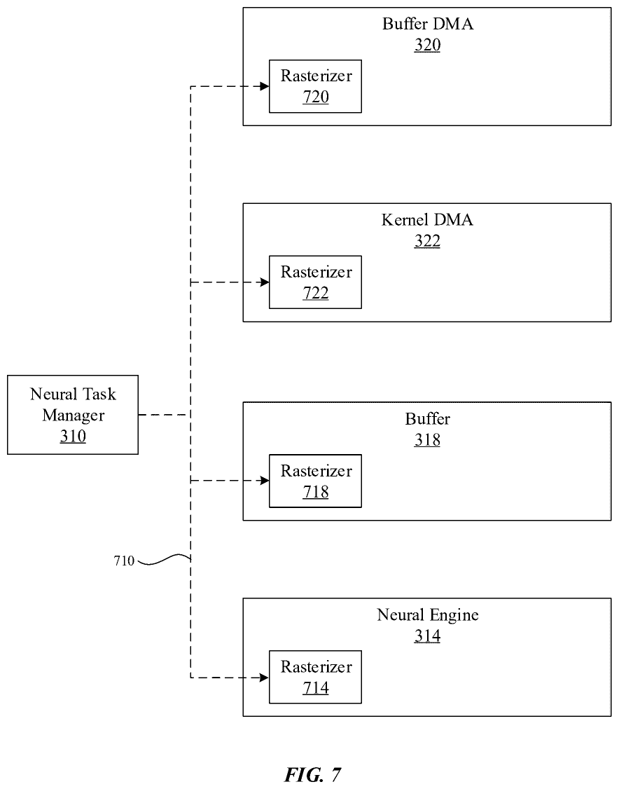

In some embodiments, the operations associated dividing the input space into smaller units and processing these smaller units as described above with reference to FIGS. 5 and 6 are performed by rasterizers 714, 718, 720, 722 of FIG. 7 in various components of neural processor circuit 218. A rasterizer is a circuit in various components of neural processor circuit 218 that keeps track of the segment of the input/output data (e.g., group, work unit, input channel, output channel) and instructs the components of neural processor circuit 218 for proper handling of the segment of the input data. For example, rasterizer 720 in buffer DMA 320 tracks tiles and slices received from system memory 230 while rasterizer 718 in data buffer 318 broadcasts in sequence work units for processing by neural engines 314. Rasterizer 724 in kernel DMA 324 determines which kernels are to be received and distributed to neural engines 314, while rasterizers 714 in neural engines 314 operate shifters 410 in input buffer circuits 402 to forward correct portions 408 of input data to MAC 404, and send the finished output data 328 to the data buffer 318.

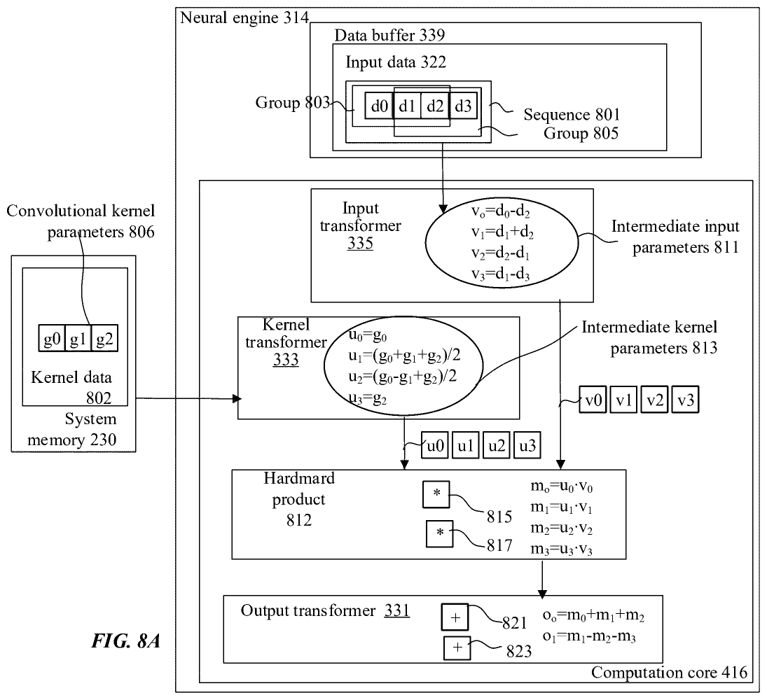

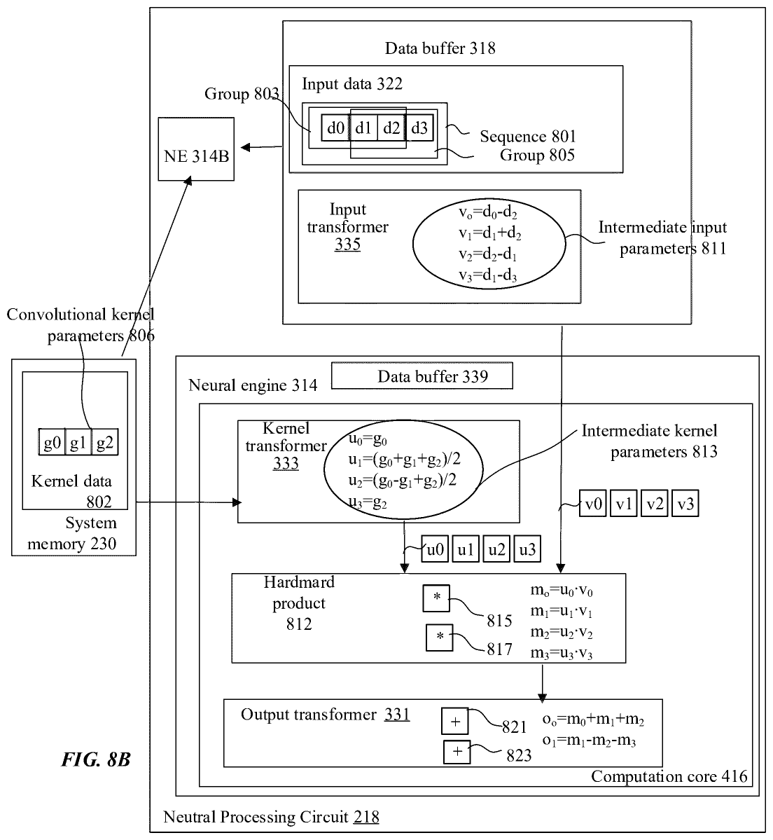

FIG. 8A is a block diagram of neural engine 314 for performing convolutions, according to some embodiments. In some embodiments, neural engine 314 can be an example of neural engine 314A, 314B, . . . , or 314N as shown in FIGS. 3B, 3C, and 4B. In some embodiments, input data 322 can include a sequence 801 of input parameters (d₀, d₁, d₂, d₃), which can correspond to the numeric value of a sequence of pixels in a row of image 353a as shown in FIG. 3C. Input data 322 can be stored in data buffer 339 that is local to NE 314, which is not shared with other NEs.

In some embodiments, sequence 801 of input parameters (d₀, d₁, d₂, d₃) can include a first group 803 of input parameters (d₀, d₁, d₂) and a second group 805 of input parameters (d₁, d₂, d₃). Each input parameter of sequence 801 of input parameters (do, d₁, d₂, d₃) can have an ordered index in increasing order. For example, input parameter do can have an index 0, input parameter d₁ can have an index 1, input parameter d₂ can have an index 2, and input parameter d₃ can have an index 3, where index 0, index 1, index 2, and index 3 are in increasing order. Second group 805 of input parameters (d₁, d₂, d₃) is obtained by shifting first group 803 of input parameters (d₀, d₁, d₂) by one index, where d₀ is shifted by one index to become d₁. In addition, convolutional kernel parameters 806 includes 3 parameters (g₀, g₁, g₂), which is a part of kernel data 802, being stored in system memory 230. In some embodiments, system memory 230 can be external to NE 314 and shared by NE 314 and other neural processor circuits.

In some embodiments, first group 803 of input parameters (d₀, d₁, d₂) is for a first convolution between first group 803 of input parameters and the number of convolutional kernel parameters (g₀, g₁, g₂), where the first convolution value can be defined by o₀=(d₀·g₀)+(d₁·g₁)+(d₂·g₂). Similarly, second group 805 of input parameters (d₁, d₂, d₃) is for a second convolution between second group 805 of input parameters and the number of convolutional kernel parameters (g₀, g₁, g₂), where the second convolution value can be defined by o₁=(d₁·g₀)+(d₂·g₁)+(d₃·g₂). In some embodiments, the first convolution is associated with a first data point 361a representing a first pixel at coordinate (0,0) of image 353a and the second convolution is associated with a second data point 361b representing a second pixel at coordinate (0,1) of image 353a adjacent to the first pixel in a row of image 353a.

In some embodiments, NE 314 can include kernel transformer 333 configured to receive the number of convolutional kernel parameters 806 from system memory 230 and to generate a number of intermediate kernel parameters 813. In some embodiments, the number of intermediate kernel parameters can be larger than the number of convolutional kernel parameters. For example, kernel transformation circuit 333 can receive 3 convolutional kernel parameters (g₀, g₁, g₂) from system memory 230 and generate a number of intermediate kernel parameters 813, such as 4 intermediate kernel parameters (u₀, u₁, u₂, u₃) defined by u₀=g₀, u₁=(g₀+g₁+g₂)/2, u₂=(g₀−g₁+g₂)/2, and u₃=g₂. Accordingly, the number of intermediate kernel parameters 813, which is 4, can be larger than 3 convolutional kernel parameters.

In some embodiments, NE 314 can include input transformer 335 configured to receive the first group 803 of input parameters and the second group 805 of input parameters, and generate intermediate input parameters 811 based on first group 803 of input parameters and second group 805 of input parameters. For example, input transformer 335 can generate 4 intermediate input parameters (v₀, v₁, v₂, v₃) defined by v₀=(d₀−d₂), v₁=(d₁+d₂), v₂=(d₂−d₁), and v₃=(d₁−d₃).

In some embodiments, NE 314 can include multipliers 812, such as a multiplier 815 and a multiplier 817, which can correspond to the number of intermediate kernel parameters 813. In some embodiments, there can be one multiplier assigned to each intermediate kernel parameter. In some embodiments, there can be two or more intermediate kernel parameters assigned to share a multiplier. A multiplier can multiply an intermediate kernel parameter by an intermediate input parameter selected from intermediate input parameters 811 generated by input transformer 335 based on the first group 803 of input parameters and the second group 805 of input parameters. In some embodiments, there can be 4 multipliers contained within multipliers 812 to generate 4 products (m₀, m₁, m₂, m₃) defined by m₀=(u₀·v₀), m₁=(u₁·v₁), m₂=(u₂·v₂), and m₃=(u₃·v₃).

In some embodiments, NE 314 can include output transformer 331, which can include a first accumulator 821 configured to generate a first convolution value of the first convolution and a second accumulator 823 configured to generate a second convolution value of the second convolution. In some embodiments, first accumulator 821 can generate the first convolution value (o₀) defined by o₀=(m₀+m₁+m₂), which is equal to o₀=(d₀·g₀)+(d₁·g₁)+(d₂·g₂) based on a Winograd transform. Similarly, second accumulator 823 can generate the second convolution value (o₁) defined by o₁=(m₁−m₂−m₃), which is equal to o₁=(d₁·g₀)+(d₂·g₁)+(d₃·g₂) based on a Winograd transform. In some embodiments, the value o₀=(m₀+m₁+m₂) and o₁=(m₁−m₂−m₃) can be generated in parallel at the same time, since both o₀ and o₁ are generated based on the products (m₀, m₁, m₂, m₃) that are output of multipliers 812.

In some embodiments, as shown above, the first convolution value (o₀) defined by o₀=(m₀+m₁+m₂) and the second convolution value (o₁) defined by o₁=(m₁−m₂−m₃) can be generated by a total of 4 multiplications m₀=(u₀·v₀), m₁=(u₁·v₁), m₂=(u₂·v₂), and m₃=(u₃·v₃). Therefore, NE 314 shown above can generate (o₀) and (o₁) using 4 multiplications, which is less than the 6 multiplications needed to generate (o₀) and (o₁) if they had been generated in sequence. Both (o₀) and (o₁) can be generated by using the same 4 products m₀=(u₀·v₀), m₁=(u₁·v₁), m₂=(u₂·v₂), and m₃=(u₃·v₃). Hence, efficiency can be gained if two convolutions (o₀) and (o₁) are generated in parallel as a pair instead of generating (o₀) and (o₁) sequentially using the formulas

$${o}_{0} = ( {d}_{0} \cdot {g}_{0} ) + ( {d}_{1} \cdot {g}_{1} ) + ( {d}_{2} \cdot {g}_{2} ) and {o}_{1} = ( {d}_{1} \cdot {g}_{0} ) + ( {d}_{2} \cdot {g}_{1} ) + ( {d}_{3} \cdot {g}_{2} ) .$$

FIG. 8B is a block diagram of neural engine 314 and neutral processing circuit 218 for performing convolutions, according to some embodiments. In some embodiments, neural engine 314 can be an example of neural engine 314A, 314B, . . . , or 314N as shown in FIGS. 3B, 3C, and 4B. In some embodiments, input data 322 can include a sequence 801 of input parameters (d₀, d₁, d₂, d₃), which can correspond to the numeric value of a sequence of pixels in a row of image 353a as shown in FIG. 3C. Input data 322 can be stored in data buffer 318 shared by multiple neural engine circuits, such as NE 314 and NE 314B.

In some embodiments, NE 314 can include kernel transformation circuit 333, multipliers 812, and output transformer 331, which can perform the same or similar functions as described above for FIG. 8A.

In some embodiments, data buffer 318 can include input transformer 335 configured to receive first group 803 of input parameters and second group 805 of input parameters and to generate intermediate input parameters 811 based on first group 803 of input parameters and second group 805 of input parameters. For example, input transformer 335 can generate 4 intermediate input parameters (v₀, v₁, v₂, v₃) defined by v₀=(d₀−d₂), v₁=(d₁+d₂), v₂=(d₂−d₁), and v₃=(d₁−d₃). In some embodiments, there can be advantages to share input transformer 335 among multiple NEs, such as NE 314 and NE 314B. When the sequence of input parameters (d₀, d₁, d₂, d₃, d₄) are floating points, operations performed by input transformer 335 would not change the format or width of the intermediate input parameters (v₀, v₁, v₂, v₃) defined by v₀=(d₀−d₂), v₁=(d₁+d₂), v₂=(d₂−d₁), and v₃=(d₁−d₃). Hence, it can be advantageous to share input transformer 335 when the sequence of input parameters (d₀, d₁, d₂, d₃, d₄) are floating points. In some embodiments, when the sequence of input parameters (d₀, d₁, d₂, d₃, d₄) are integers, such as signed or unsigned integers, operations performed by input transformer 335 may change the format or width of the intermediate input parameters (v₀, v₁, v₂, v₃) defined by v₀=(d₀−d₂), v₁=(d₁+d₂), v₂=(d₂−d₁), and v₃=(d₁−d₃). Accordingly, placing input transformer 335 inside data buffer 318 shared by multiple NEs can cause some penalty for communication between input transformer 335 and NE 314. Hence, it may be more advantageous to place input transformer 335 within data buffer 339 local to NE 314, as shown in FIG. 8A.

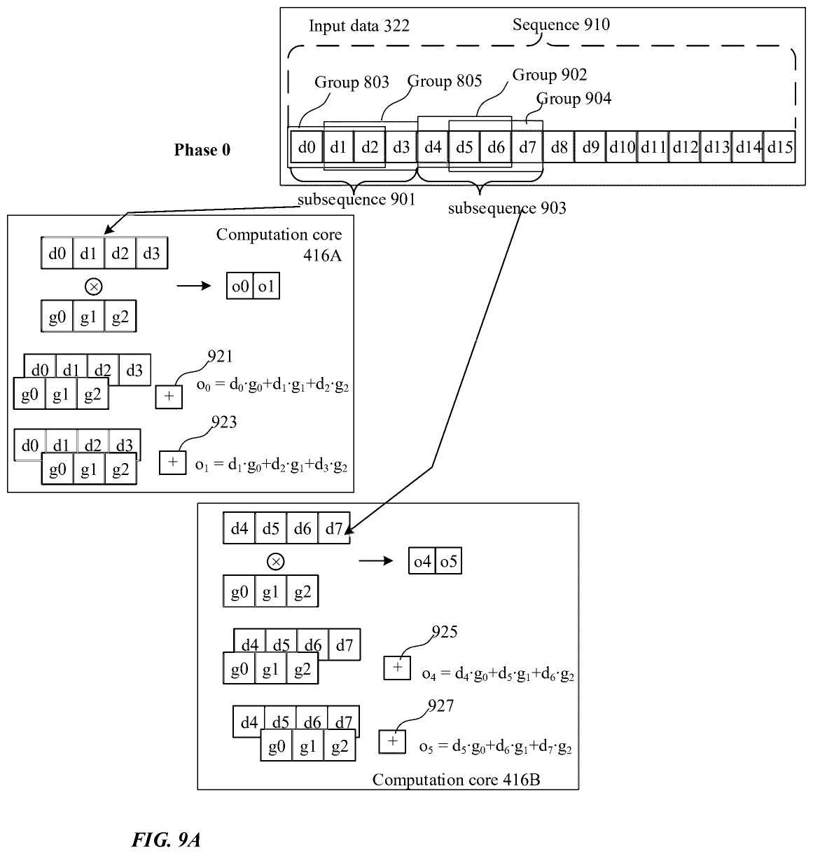

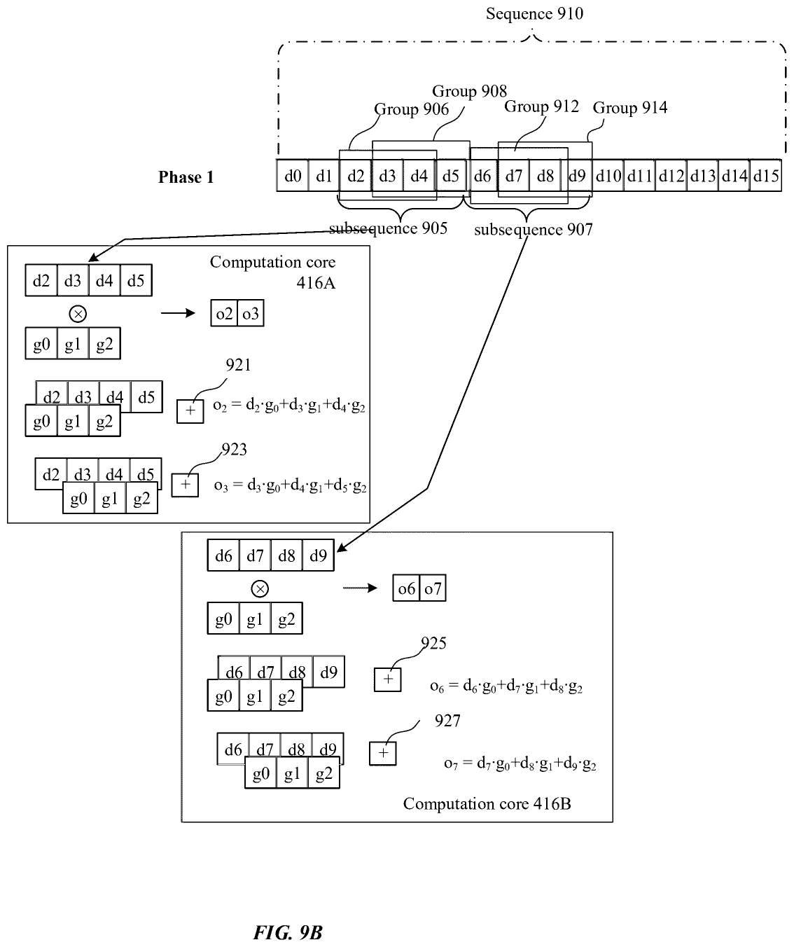

FIG. 9A is a diagram illustrating multiple convolutions computed by computation cores 416A and 416B of a neural engine and neutral processing circuit, according to some embodiments. In some embodiments, computation cores 416A and 416B can be an example of computation cores 416 as shown in FIGS. 8A and 8B. In some embodiments, input data 322 can include a sequence 910 of input parameters (d₀, d₁, d₂, d₃, . . . , d₁₅), which can correspond to the numeric value of a sequence of pixels in a row of image 353a as shown in FIG. 3C. Input data 322 can be stored in data buffer 339 that is local to NE 314 as shown in FIG. 8A, or in data buffer 318 that is external to NE 314 as shown in FIG. 8B. In some embodiments, computation core 416A or 416B can be an example of computation core 416 as shown in FIG. 8A or FIG. 8B, which can be configured to generate two convolution values in parallel.

In some embodiments, each input parameter of sequence 910 of input parameters (d₀, d₁, d₂, d₃, . . . , d₁₅) can have an index, which is in increasing order. For example, input parameter d₀ can have an index 0, while input parameter d₁₅ can have an index 15. In addition, each input parameter can have a value or a number of a data point. For example, input parameter d₀ can be the number representing a pixel at the coordinate (0,0) of image 353a as shown in FIG. 3C.

In some embodiments, sequence 910 can be divided into multiple subsequences, e.g., subsequence 901, subsequence 903, where the subsequences can be disjointed from each other. Each subsequence can include multiple groups of input parameters. Subsequence 901 can include first group 803 of input parameters (d₀, d₁, d₂) and second group 805 of input parameters (d₁, d₂, d₃), which are similar to the sequence shown in FIG. 8A. In addition, subsequence 903 can include a third group 902 of input parameters (d₄, d₅, d₆), and a fourth group 904 of input parameters (d₅, d₆, d₇). In some embodiments, second group 805 of input parameters (d₁, d₂, d₃) can be obtained by shifting first group 803 of input parameters (d₀, d₁, d₂) by one index within subsequence 901. Similarly, fourth group 904 of input parameters (d₅, d₆, d₇) can be obtained by shifting third group 902 of input parameters (d₄, d₅, d₆) by one index within subsequence 903. In some embodiments, a union sequence of subsequence 901 and subsequence 903 can include input parameters (d₀, d₁, d₂, d₃, d₄, d₅, d₆, d₇).

In some embodiments, computation core 416A can include a first accumulator 921 configured to generate a first convolution value of a first convolution between first group 803 of input parameters (d₀, d₁, d₂) and convolutional kernel parameters (g₀, g₁, g₂), which can be defined by o₀=d₀·g₀+d₁·g₁+d₂·g₂. In addition, computation core 416A can include a second accumulator 923 configured to generate a second convolution value of a second convolution between second group 805 of input parameters (d₁, d₂, d₃) and convolutional kernel parameters (g₀, g₁, g₂), which can be defined by o₁=d₁·g₀+d₂·g₁+d₃·g₂. In some embodiments, the computation of o₀=d₀·g₀+d₁·g₁+d₂·g₂ and o₁=d₁·g₀+d₂·g₁+d₃·g₂ can be performed using kernel transformation circuit 333, multipliers 812, and output transformer 331, as shown in FIGS. 8A and 8B. Accordingly, computation core 416A can include multipliers configured to multiply intermediate kernel parameters by intermediate input parameters generated based on first group 803 of input parameters (d₀, d₁, d₂) and second group 805 of input parameters (d₁, d₂, d₃).

In some embodiments, computation core 416B can include a third accumulator 925 configured to generate a third convolution value of a third convolution between third group 902 of input parameters (d₄, d₅, d₆) and convolutional kernel parameters (g₀, g₁, g₂), which can be defined by o₄=d₄·g₀+d₅·g₁+d₆·g₂. In addition, computation core 416B can include a fourth accumulator 927 configured to generate a fourth convolution value of a fourth convolution between fourth group 904 of input parameters (d₅, d₆, d₇) and convolutional kernel parameters (g₀, g₁, g₂), which can be defined by o₅=d₅·g₀+d₆·g₁+d₇·g₂. In some embodiments, the computation of o₄=d₄·g₀+d₅·g₁+d₆·g₂ and o₅=d₅·g₀+d₆·g₁+d₇·g₂ can be performed using kernel transformation circuit 333, multipliers 812, and output transformer 331, as shown in FIGS. 8A and 8B. Accordingly, computation core 416B can include multipliers configured to multiply intermediate kernel parameters by intermediate input parameters generated based on third group 902 of input parameters (d₄, d₅, d₆) and fourth group 904 of input parameters (d₅, d₆, d₇).

In some embodiments, as shown in FIG. 9B, sequence 910 can include multiple subsequences, e.g., subsequence 905 and subsequence 907 disjointed from subsequence 905. Each subsequence can include multiple groups of input parameters. Subsequence 905 can include a fifth group 906 of input parameters (d₂, d₃, d₄) and a sixth group 908 of input parameters (d₃, d₄, d₅). In addition, subsequence 907 can include a seventh group 912 of input parameters (d₆, d₇, d₈) and an eighth group 914 of input parameters (d₇, d₈, d₉). In some embodiments, sixth group 908 of input parameters (d₃, d₄, d₅) can be obtained by shifting fifth group 906 of input parameters (d₂, d₃, d₄) by one index within subsequence 905. Similarly, eighth group 914 of input parameters (d₇, d₈, d₉) can be obtained by shifting seventh group 912 of input parameters (d₆, d₇, d₈) by one index within subsequence 907. In some embodiments, a union sequence of subsequence 905 and subsequence 907 can include input parameters (d₂, d₃, d₄, d₅, d₆, d₇, d₈, d₉).

In some embodiments, first accumulator 921 can be configured to generate a fifth convolution value of a fifth convolution between fifth group 906 of input parameters (d₂, d₃, d₄) and convolutional kernel parameters (g₀, g₁, g₂), which can be defined by o₂=d₂·g₀+d₃·g₁+d₄·g₂. In addition, second accumulator 923 can be configured to generate a sixth convolution value of a sixth convolution between sixth group 908 of input parameters (d₃, d₄, d₅) and convolutional kernel parameters (g₀, g₁, g₂), which can be defined by o₃=d₃·g₀+d₄·g₁+d₅·g₂. In some embodiments, the computation of o₂=d₂·g₀+d₃·g₁+d₄·g₂ and o₃=d₃·g₀+d₄·g₁+d₅·g₂ can be performed using kernel transformation circuit 333, multipliers 812, and output transformer 331, as shown in FIGS. 8A and 8B.

In some embodiments, third accumulator 925 can be configured to generate a seventh convolution value of a seventh convolution between seventh group 912 of input parameters (d₆, d₇, d₈) and convolutional kernel parameters (g₀, g₁, g₂), which can be defined by o₆=d₆·g₀+d₇·g₁+d₈·g₂. In addition, fourth accumulator 927 can be configured to generate an eighth convolution value of an eighth convolution between eighth group 914 of input parameters (d₇, d₈, d₉) and convolutional kernel parameters (g₀, g₁, g₂), which can be defined by o₇=d₇·g₀+d₈·g₁+d₉·g₂. In some embodiments, the computation of o₆=d₆·g₀+d₇·g₁+d₈·g₂ and o₇=d₇·g₀+d₈·g₁+d₉·g₂ can be performed using kernel transformation circuit 333, multipliers 812, and output transformer 331, as shown in FIGS. 8A and 8B.

In some embodiments, as described above, first accumulator 921 is configured to generate the first convolution value o₀=d₀·g₀+d₁·g₁+d₂·g₂ at a first time instance and generate a fifth convolution value o₂=d₂·g₀+d₃·g₁+d₄·g₂ at a second time instance; and second accumulator 923 is configured to generate the second convolution value o₁=d₁·g₀+d₂·g₁+d₃·g₂ at the first time instance and generate a sixth convolution value o₃=d₃·g₀+d₄·g₁+d₅·g₂ at the second time instance. Therefore, the first convolution value o₀=d₀·g₀+d₁·g₁+d₂·g₂ and the second convolution value o₁=d₁·g₀+d₂·g₁+d₃·g₂ are computed in parallel at the first time instance, which can be referred to as “phase 0 computation.” In addition, the fifth convolution value o₂=d₂·g₀+d₃·g₁+d₄·g₂ and the sixth convolution value o₃=d₃·g+d₄·g₁+d₅·g₂ are computed in parallel at the second time instance, which can be referred to as “phase 1 computation.” In addition, the third convolution value o₄=d₄·g₀+d₅·g₁+d₆·g₂ and the fourth convolution value o₅=d₅·g₀+d₆·g₁+d₇·g₂ are computed in parallel at the first time instance. In some embodiments, the second time instance is after the first time instance when the operations are implemented in a pipelined manner. In some embodiments, the second time instance can be at the same as the first time instance when the operations are implemented in a parallel manner.

In some embodiments, the first convolution value o₀=d₀·g₀+d₁·g₁+d₂·g₂ can be associated with a data point representing pixel (0,0) of image 328a, the second convolution value o₁=d₁·g₀+d₂·g₁+d₃·g₂ is associated with a data point representing pixel (0, 1) of image 328a adjacent to the pixel (0,0), the fifth convolution value o₂=d₂·g₀+d₃·g₁+d₄·g₂ can be associated with a data point representing pixel (0,2) of image 328a, the sixth convolution value o₃=d₃·g₀+d₄·g₁+d₅·g₂ can be associated with a data point representing pixel (0,3) of image 328a, the third convolution value o₄=d₄·g₀+d₅·g₁+d₆·g₂ can be associated with a data point representing pixel (0,4) of image 328a, and the fourth convolution value o₅=d₅·g₀+d₆·g₁+d₇·g₂ an be associated with a data point representing pixel (0,5) of image 328a. Accordingly, data point (0, 2) associated with the fifth convolution value and data point (0,3) associated with the sixth convolution value are located in the row of the image between a group of the first data point (0, 0) and the second data point (0, 1) and another group of the third data point (0, 4) and the fourth data point (0, 5).

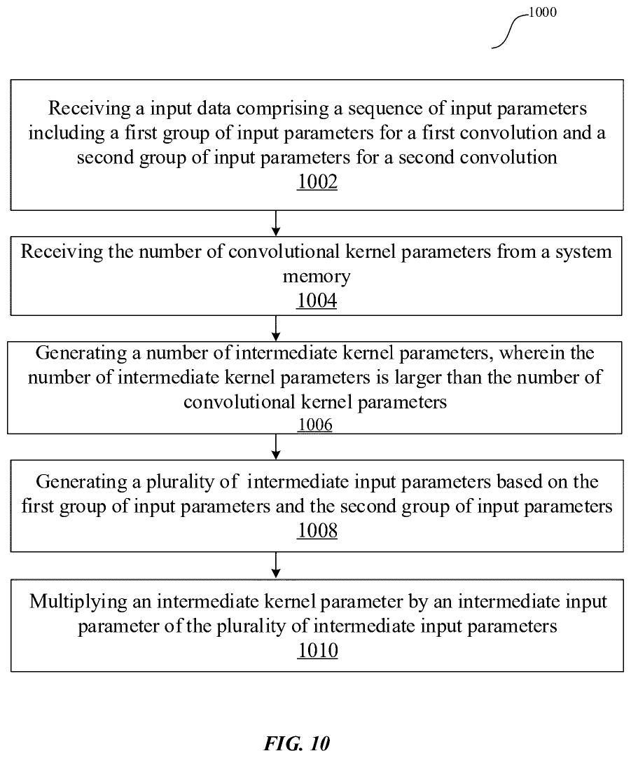

FIG. 10 is a flowchart illustrating a method for computing multiple convolutions, according to some embodiments. For illustrative purposes, the operations illustrated in process 1000 will be described with reference to neural processor circuit 218 and neural engine 314 as shown in FIGS. 3B, 3C, 4A, 4B, 8A, and 8B. Other representations of systems for performing operations of process 1000 are possible. Also, additional operations may be performed between various operations of process 1000 and may be omitted merely for clarity and ease of description. The additional operations can be provided before, during, and/or after process 1000. Moreover, not all operations may be needed to perform the disclosure provided herein. Additionally, some of the operations may be performed simultaneously or in a different order than shown in FIG. 10. In some embodiments, one or more other operations may be performed in addition to or in place of the presently-described operations.

At operation 1002, neural processor circuit 218 can receive input data 322 including a sequence 801 (d₀, d₁, d₂, d₃) of input parameters with first group 803 of input parameters (d₀, d₁, d₂) for a first convolution and second group 805 of input parameters (d₁, d₂, d₃) for a second convolution. The first convolution is between the first group 803 of input parameters (d₀, d₁, d₂) and a number of convolutional kernel parameters (g₀, g₁, g₂), and the second convolution is between the second group 805 of input parameters (d₁, d₂, d₃) and the number of convolutional kernel parameters (g₀, g₁, g₂).

At operation 1004, kernel transformation circuit 333 can receive the number of convolutional kernel parameters (g₀, g₁, g₂) from system memory 230.

At operation 1006, kernel transformation circuit 333 can generate a number of intermediate kernel parameters 813, such as 4 intermediate kernel parameters (u₀, u₁, u₂, u₃) defined by u₀=g₀, u₁=(g₀+g₁+g₂)/2, u₂=(g₀−g₁+g₂)/2, and u₃=g₂.

At operation 1008, input transformer 335 can generate a number of intermediate input parameters. For example, input transformer 335 can generate 4 intermediate input parameters (v₀, v₁, v₂, v₃) defined by v₀=(d₀−d₂), v₁=(d₁+d₂), v₂=(d₂−d₁), and v₃=(d₁−d₃).

At operation 1010, multipliers 812, such as a multiplier 815 and a multiplier 817 can multiply an intermediate kernel parameter by an intermediate input parameter of the intermediate input parameters. In some embodiments, there can be 4 multipliers in multipliers 812 to generate 4 products (m₀, m₁, m₂, m₃) defined by m₀=(u₀·v₀), m₁=(u₁·v₁), m₂=(u₂·v₂), and m₃=(u₃·v₃).

In some embodiments, the number of convolutional kernel parameters includes 3 convolutional kernel parameters (g₀, g₁, g₂), the first group of input parameters includes 3 input parameters (d₀, d₁, d₂), the second group of input parameters includes 3 input parameters (d₁, d₂, d₃), where a first convolution value (o₀) of the first convolution between the first group of input parameters and the number of convolutional kernel parameters is defined by o=(d₀·g₀)+(d₁·g₁)+(d₂·g₂), and a second convolution value (o₁) of the second convolution between the second group of input parameters and the number of convolutional kernel parameters is defined by o₁=(d₁·g₀)+(d₂·g₁)+(d₃·g₂). The number of intermediate kernel parameters includes 4 intermediate kernel parameters (u₀, u₁, u₂, u₃) defined by u₀=g₀, u₁=(g₀+g₁+g₂)/2, u₂=(g₀−g₁+g₂)/2, and u₃=g₂. The first convolution value (o₀) and the second convolution value (o₁) are generated based on 4 intermediate input parameters (v₀, v₁, v₂, v₃) defined by v₀=(d₀−d₂), v₁=(d₁+d₂), v₂=(d₂−d₁), and v₃=(d₁−d₃). The first convolution value (o₀) defined by o₀=(m₀+m₁+m₂); and the second convolution value (o₁) defined by o₁=(m₁−m₂−m₃).

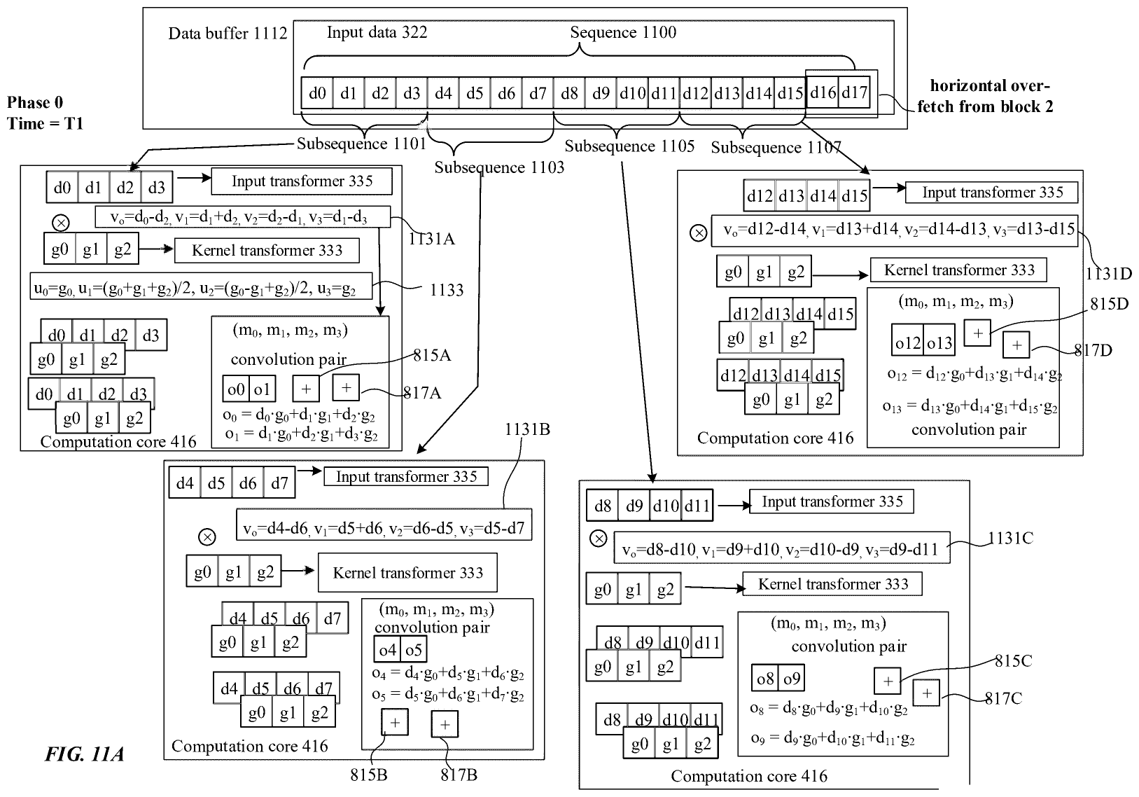

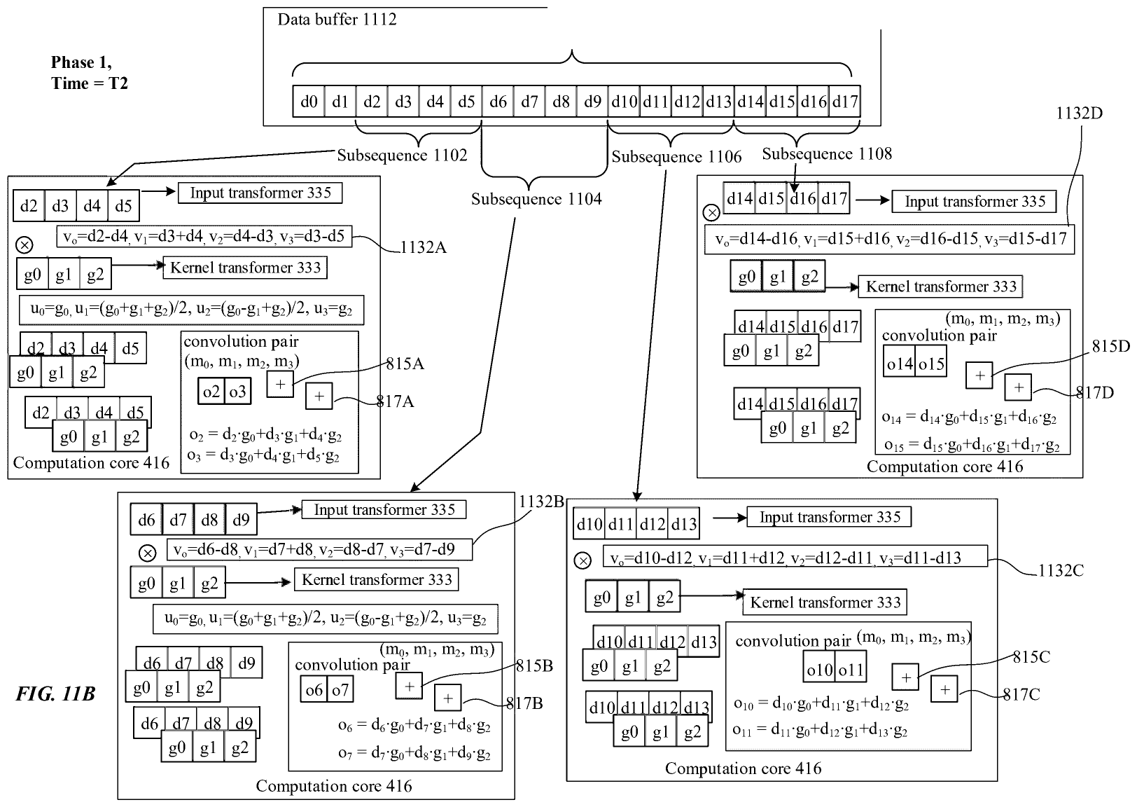

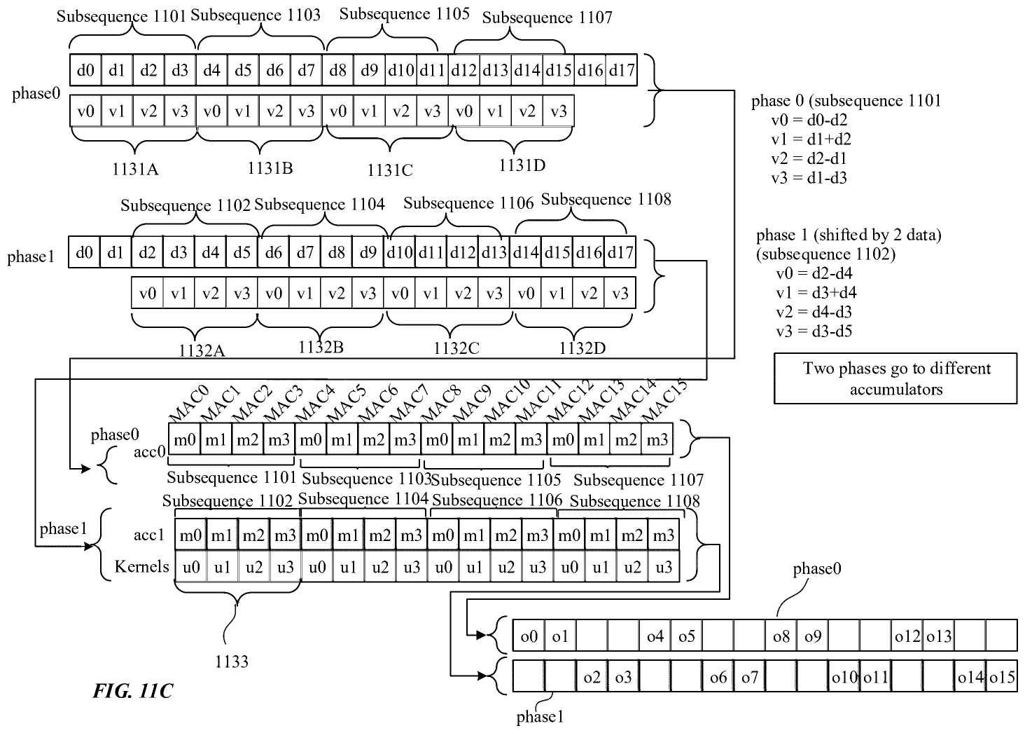

FIGS. 11A-11C are diagrams illustrating multiple pairs of convolutions computed by computation cores of neural engines or neutral processing circuits in two phases in a pipelined manner, according to some embodiments. Computations illustrated in FIG. 11A are performed at phase 0 at a first time instance—time T1, while computations illustrated in FIG. 11B are performed at phase 1 at a second time instance—time T2, where the computations are performed on a sequence 1110 of input parameters (d₀, d₁, d₂, d₃, . . . , d₁₅, d₁₆, d₁₇). In some embodiments, computation cores 416 can be an example of computation core 416 as shown in FIGS. 8A and 8B, which can generate or produce the values of a pair of convolutions in parallel. In some embodiments, input data 322 can be stored in a data buffer 1112. In some embodiments, data buffer 1112 can be an example of data buffer 339 that is local to a neural engine. In some embodiments, data buffer 1112 can be an example of data buffer 318 that is external to a neural engine and shared by multiple neural engines.

In some embodiments, input data 322 can include sequence 1110 of 18 input parameters (d₀, d₁, d₂, d₃, . . . , d₁₅, d₁₆, d₁₇). Sequence 1110 having 18 input parameters is provided as an example. In some embodiments, there can be other lengths for sequence 1110, such as sequence 1110 including (d₀, d₁, d₂, d₃, . . . , d₁₅), (d₀, d₁, d₂, d₃, . . . , d₉), (d₀, d₁, d₂, d₃, . . . , d₇), a sequence of length 128, a sequence of length 130, or other lengths. In some embodiments, sequence 1110 of input parameters (d₀, d₁, d₂, d₃, . . . , d₁₅, d₁₆, d₁₇) can correspond to the numeric values of a sequence of pixels in a row of image 328a as shown in FIG. 3C. The description below for sequence 1110 of input parameters (d₀, d₁, d₂, d₃, . . . , d₁₅, d₁₆, d₁₇) can be applicable for a sequence of a different length as well.

In some embodiments, sequence 1110 of input parameters (d₀, d₁, d₂, d₃, . . . , d₁₅, d₁₆, d₁₇) can include a subsequence 1101 of input parameters (d₀, d₁, d₂, d₃), a subsequence 1103 of input parameters (d₄, d₅, d₆, d₇), a subsequence 1105 of input parameters (d₈, d₉, d₁₀, d₁₁), and a subsequence 1107 of input parameters (d₁₂, d₁₃, d₁₄, d₁₅), where subsequence 1101, subsequence 1103, subsequence 1105, and subsequence 1107 can be disjointed from one another. Each input parameter of sequence 1110 can have an index assigned in an increasing order. For example, input parameter d₀ can have an index 0, while input parameter d₁₅ can have an index 15. In some embodiments, two subsequences can form a union sequence, which is a sequence formed according to the index order of the two subsequences. For example, subsequence 1101 and subsequence 1103 can have a union sequence (d₀, d₁, d₂, d₃, d₄, d₅, d₆, d₇).

In some embodiments, sequence 1110 can have different ways to form subsequences. For example, as shown in FIG. 11B, sequence 1110 can include a subsequence 1102 of input parameters (d₂, d₃, d₄, d₅), a subsequence 1104 of input parameters (d₆, d₇, d₈, d₉), a subsequence 1106 of input parameters (d₁₀, d₁, d₁₂, d₁₃), and a subsequence 1108 of input parameters (d₁₄, d₁₅, d₁₆, d₁₇), where subsequence 1102, subsequence 1104, subsequence 1106, and subsequence 1108 can be disjointed from one another. In addition, subsequence 1102 of input parameters (d₂, d₃, d₄, d₅) is included in the union sequence of subsequence 1101 and subsequence 1103. Subsequence 1102 can be obtained by shifting subsequence 1101 of input parameters (d₀, d₁, d₂, d₃) by two indices within sequence 1110, where input parameter d₀ in subsequence 1101 is shifted to become input parameter d₂ in subsequence 1102. Similarly, subsequence 1102 and subsequence 1104 can form a union sequence (d₂, d₃, d₄, d₅, d₆, d₇, d₈, d₉), which can be a shifted subsequence of the union sequence of subsequence 1101 and subsequence 1103.

In some embodiments, each subsequence shown in FIGS. 11A-11B, e.g., subsequence 1101, subsequence 1102, . . . , subsequence 1107, or subsequence 1108, can include input parameters for a pair of convolutions. In some embodiments, the pair of convolutions for each subsequence can be performed as illustrated in FIGS. 8A-8B described above. Accordingly, subsequence 1101 can include input parameters for a pair of convolutions having a first convolution value (o₀) and a second convolution value (o₁), which can be computed in parallel. In some embodiments, subsequence 1101 of input parameters (d₀, d₁, d₂, d₃) includes a first group of 3 input parameters (d₀, d₁, d₂) and a second group of 3 input parameters (d₁, d₂, d₃), where convolution value (o₀) is defined by o₀=(d₀·g₀)+(d₁·g₁)+(d₂·g₂) and convolution value (o₁) is defined by o₁=(d₁·g₀)+(d₂·g₁)+(d₃·g₂).

Similarly, subsequence 1103 can include input parameters for a pair of convolutions having a first convolution value (o₄) and a second convolution value (o₅). In addition, subsequence 1105 can include input parameters for a pair of convolutions having a first convolution value (o₈) and a second convolution value (o₉). Furthermore, subsequence 1107 can include input parameters for a pair of convolutions having a first convolution value (o₁₂) and a second convolution value (o₁₃). Accordingly, convolution values (o₀, o₁, o₄, o₅, o₈, o₉, o₁₂, o₁₃) are computed at phase 0 at the first time instance T1. In addition, as shown in FIG. 11B, multiple pairs of convolution values (o₂, o₃, o₆, o₇, o₁₀, o₁₁, o₁₄, o₁₅) are computed at phase 1 at the second time instance T2. Therefore, the computation of convolution values for sequence 1110 of input parameters (d₀, d₁, d₂, d₃, . . . , d₁₅, d₁₆, d₁₇) are performed in a pipelined manner in phase 0 and phase 1, where (o₀, o₁, o₄, o₅, o₈, o₉, o₁₂, o₁₃) are computed at phase 0 while (o₂, o₃, o₆, o₇, o₁₀, o₁₁, o₁₄, o₁₅) are computed at phase 1. In addition, the computation at phase 0 and the computation at phase 1 can share the same computation cores or neural engines. Therefore, the pipelined computation of convolution values (o₀, o₁, o₄, o₅, o₈, o₉, o₁₂, o₁₃) at phase 0 and convolution values (o₂, o₃, o₆, o₇, o₁₀, o₁₁, o₁₄, o₁₅) at phase 1 can be enhanced (e.g., faster computation speed), while using smaller hardware in comparison with computing all the convolution values in parallel. In some embodiments, convolution values computed at phase 0 include pairs of convolutions separated by 2 indices between adjacent pairs. Similarly, convolution values computed at phase 1 include pairs of convolutions separated by 2 indices between adjacent pairs. In addition, convolution values computed at phase 0 and at phase 1 are interleaved with convolution pairs.

In some embodiments, the pair of convolutions (o₀, o₁) for subsequence 1101 are associated with a first pair of data points (d₀, d₁) of an image, respectively, where convolution value o₀ is associated with data point d₀ since d₀ only occurs in the computation of o₀. Similarly, after data point d₀, convolution value o₁ is associated with data point d₁ since d₁ occurs only in the computation of o₁ but not other convolution values after o₁. Therefore, the first pair of data points includes two adjacent data points d₀ and d₁ in the image. In addition, the pair of convolutions (o₄, o₅) for subsequence 1103 are associated with a second pair of data points (d₄, d₅) of the image, respectively. Therefore, the second pair of data points includes two adjacent data points d₄ and d₅ in the image. Furthermore, the pair of convolutions (o₂, o₃) are associated with a pair of data points (d₂, d₃) of the image, respectively, which represent two adjacent data points d₂ and d₃. Accordingly, the pair of data points (d₂, d₃) are located between the first pair of data points (d₀, d₁) and the second pair of data points (d₄, d₅). In addition, data point d₂ is adjacent to data point d₁ and data point d₃ is adjacent to data point d₄.

In some embodiments, convolution value o₀ can be associated with a first data point representing a first pixel of image 328a, e.g., pixel at coordinate (0,0), and convolution value o₁ can be associated with a second data point representing a second pixel of image 328a adjacent to the first pixel in a row of the image, e.g., pixel at coordinate (0,1). In some embodiments, the union sequence of subsequence 1101 and subsequence 1103, which is (d₀, d₁, d₂, d₃, d₄, d₅, d₆, d₇), can represent data points of a block of data points of image 353a when a size of a block of data points is 8. In addition, the union sequence of subsequence 1102 and subsequence 1104, which is (d₂, d₃, d₄, d₅, d₆, d₇, d₈, d₉), represents data points of a part of the block of data points, e.g., (d₂, d₃, d₄, d₅, d₆, d₇), plus two over-fetched data points of the block, e.g., (d₈, d₉).

In some embodiments, the computation of convolution values (o₀, o₁, o₄, o₅, o₈, o₉, o₁₂, o₁₃) at phase 0 and convolution values (o₂, o₃, o₆, o₇, o₁₀, o₁₁, o₁₄, o₁₅) at phase 1 are based on a same set of convolutional kernel parameters. In some embodiments, the convolutional kernel parameters can include 3 convolutional kernel parameters (g₀, g₁, g₂). In some embodiments, kernel transformer 333, which is a kernel transformation circuit, can receive the number of convolutional kernel parameters (g₀, g₁, g₂) from a system memory, e.g., system memory 230. Afterwards, kernel transformer 333 can generate a set 1133 of intermediate kernel parameters, which can include 4 intermediate kernel parameters (u₀, u₁, u₂, u₃) defined by u₀=g₀, u₁=(g₀+g₁+g₂)/2, u₂=(g₀−g₁+g₂)/2, and u₃=g₂, as shown in FIGS. 8A-8B. Accordingly, set 1133 of intermediate kernel parameters can be larger than the number of convolutional kernel parameters (g₀, g₁, g₂). As shown in FIGS. 11A-11B, there can be kernel transformer 333 within computation core 416 for each subsequence of subsequence 1101, subsequence 1108. In some embodiments, kernel transformer 333 can be implemented within each computation core. In some embodiments, kernel transformer 333 can be shared among multiple computation cores for multiple subsequences.

In some embodiments, for subsequence 1101, computation core 406 can include input transformer 335 configured to receive subsequence 1101 and to generate a set 1131A of intermediate input parameters corresponding to subsequence 1101. For example, input transformer 335 can generate set 1131A having 4 intermediate input parameters (v₀, v₁, v₂, v₃) defined by v₀=(d₀−d₂), v₁=(d₁+d₂), v₂=(d₂−d₁), and v₃=(d₁−d₃). Similarly, for subsequence 1103, input transformer 335 can generate a set 1131B having 4 intermediate input parameters (v₀, v₁, v₂, v₃) defined by v₀=(d₄−d₆), v₁=(d₅+d₆), v₂=(d₆−d₅), and v₃=(d₅−d₇). In addition, for subsequence 1105, input transformer 335 can generate a set 1131C having 4 intermediate input parameters (v₀, v₁, v₂, v₃) defined by v₀=(d₈−d₁₀), v₁=(d₉+d₁₀), v₂=(d₁₀−d₉), and v₃=(d₉−d₁₁). For subsequence 1105, input transformer 335 can generate a set 1131D having 4 intermediate input parameters (v₀, v₁, v₂, v₃) defined by v₀=(d₁₂−d₁₄), v₁=(d₁₃+d₁₄), v₂=(d₁₄−d₁₃), and v₃=(d₁₃−d₁₅).

In a similar manner, as shown in FIG. 11B, input transformer 335 can perform the following operations: generate a set 1132A having 4 intermediate input parameters (v₀, v₁, v₂, v₃) defined by v₀=(d₂−d₄), v₁=(d₃+d₄), v₂=(d₄−d₃), and v₃=(d₃−d₅); generate a set 1132B having 4 intermediate input parameters (v₀, v₁, v₂, v₃) defined by v₀=(d₆−d₈), v₁=(d₇+d₈), v₂=(d₈−d₇), and v₃=(d₇−d₉); generate a set 1132C having 4 intermediate input parameters (v₀, v₁, v₂, v₃) defined by v₀=(d₁₀−d₁₂), v₁=(d₁₁+d₁₂), v₂=(d₁₂−d₁₁), and v₃=(d₁₁−d₁₃); and generate a set 1132D having 4 intermediate input parameters (v₀, v₁, v₂, v₃) defined by v₀=(d₁₄−d₁₆), v₁=(d₁₅+d₁₆), v₂=(d₁₆−d₁₅), and v₃=(d₁₅−d₁₇).

In some embodiments, computation core 406 can include one or more multipliers corresponding to the number of intermediate kernel parameters, where a multiplier can multiply an intermediate kernel parameter by an intermediate input parameter. In some embodiments, the one or more multipliers can generate 4 products (m₀, m₁, m₂, m₃) defined by m₀=(u₀·v₀), m₁=(u₁·v₁), m₂=(u₂·v₂), and m₃=(u₃·v₃). In some embodiments, there can be 4 multipliers to perform the 4 multiplications in parallel. In some embodiments, there can be fewer than 4 multipliers that performs the 4 multiplications in a pipelined manner or in sequence.

In some embodiments, computation core 406 can include a pair of accumulators configured to generate a pair of convolution values for the pair of convolutions defined by a subsequence. As shown in FIG. 11A, at the first time instance T1 for phase 0, a pair of accumulators 815A and 817A can generate the convolution value (o₀) defined by o₀=(m₀+m₁+m₂) and the convolution value (o₁) defined by o₁=(m₁−m₂−m₃). Similarly, a pair of accumulators 815B and 817B can generate the pair of convolution values (o₄, o₅), a pair of accumulators 815C and 817C can generate the pair of convolution values (o₈, o₉), and a pair of accumulators 815D and 817D can generate the pair of convolution values (o₁₂, o₁₃).

In some embodiments, at the second time instance T2 for phase 1, as shown in FIG. 11B, accumulators 815A and 817A can generate the convolution value pair (o₂, o₃), accumulators 815B and 817B can generate the pair of convolution values (o₆, o₇), accumulators 815C and 817C can generate the pair of convolution values (o₁₀, o₁₁), and a pair of accumulators 815D and 817D can generate the pair of convolution values (o₁₄, o₁₅).

FIG. 11C illustrates the two phases of pipelined computation of convolution values (o₀, o₁, o₄, o₅, o₈, o₉, o₁₂, o₁₃) at phase 0 and convolution values (o₂, o₃, o₆, o₇, o₁₀, o₁₁, o₁₄, o₁₅) at phase 1 based on a same set of convolutional kernel parameters (g₀, g₁, g₂). Kernel transformer 333 can generate set 1133 of intermediate kernel parameters, which can include 4 intermediate kernel parameters (u₀, u₁, u₂, u₃) defined by

$${u}_{o} = {g}_{0} , {u}_{1} = ( {g}_{0} + {g}_{1} + {g}_{2} ) / 2 , {u}_{2} = ( {g}_{0} - {g}_{1} + {g}_{2} ) / 2 , and {u}_{3} = {g}_{2} .$$

In some embodiments, during phase 0, input transformer 335 can transform a subsequence of input parameters into a set of intermediate input parameters, which can include set 1131A of intermediate input parameters (v₀, v₁, v₂, v₃) corresponding to subsequence 1101, set 1131B of intermediate input parameters (v₀, v₁, v₂, v₃) corresponding to subsequence 1103, set 1131C of intermediate input parameters (v₀, v₁, v₂, v₃) corresponding to subsequence 1105, and set 1131D of intermediate input parameters (v₀, v₁, v₂, v₃) corresponding to subsequence 1107. A set of products (m₀, m₁, m₂, m₃) defined by m₀=(u₀·v₀), m₁=(u₁·v₁), m₂=(u₂·v₂), and m₃=(u₃·v₃) for subsequence 1101, subsequence 1103, subsequence 1105, and subsequence 1107 can be produced. Afterwards, accumulators MAC0, . . . , MAC15 can generate the multiple pairs of convolution values (o₀, o₁, o₄, o₅, o₈, o₉, o₁₂, o₁₃) at phase 0.

Similarly, during phase 1, input transformer 335 can transform a subsequence of input parameters into a set of intermediate input parameters, which can include set 1132A of intermediate input parameters (v₀, v₁, v₂, v₃) corresponding to subsequence 1102, set 1132B of intermediate input parameters (v₀, v₁, v₂, v₃) corresponding to subsequence 1104, set 1132C of intermediate input parameters (v₀, v₁, v₂, v₃) corresponding to subsequence 1106, and set 1132D of intermediate input parameters (v₀, v₁, v₂, v₃) corresponding to subsequence 1108. A set of products (m₀, m₁, m₂, m₃) defined by m₀=(u₀·v₀), m₁=(u₁·v₁), m₂=(u₂·v₂), and m₃=(u₃·v₃) for subsequence 1102, subsequence 1104, subsequence 1106, and subsequence 1108 can be produced. Afterwards, accumulators MAC0, . . . , MAC15 can generate the multiple pairs of convolution values (o₂, o₃, o₆, o₇, o₁₀, o₁₁, o₁₄, o₁₅) at phase 1.

In some embodiments, as shown in FIG. 11C, the pair of convolution values (o₀, o₁) can be produced first at phase 0, followed by the pair of convolution values (o₄, o₅). In addition, the pair of convolution values (o₂, o₃) can be produced at phase 1, which represent data points between the data points for the pair of convolution values (o₀, o₁) and the data points for the pair of convolution values (o₄, o₅).

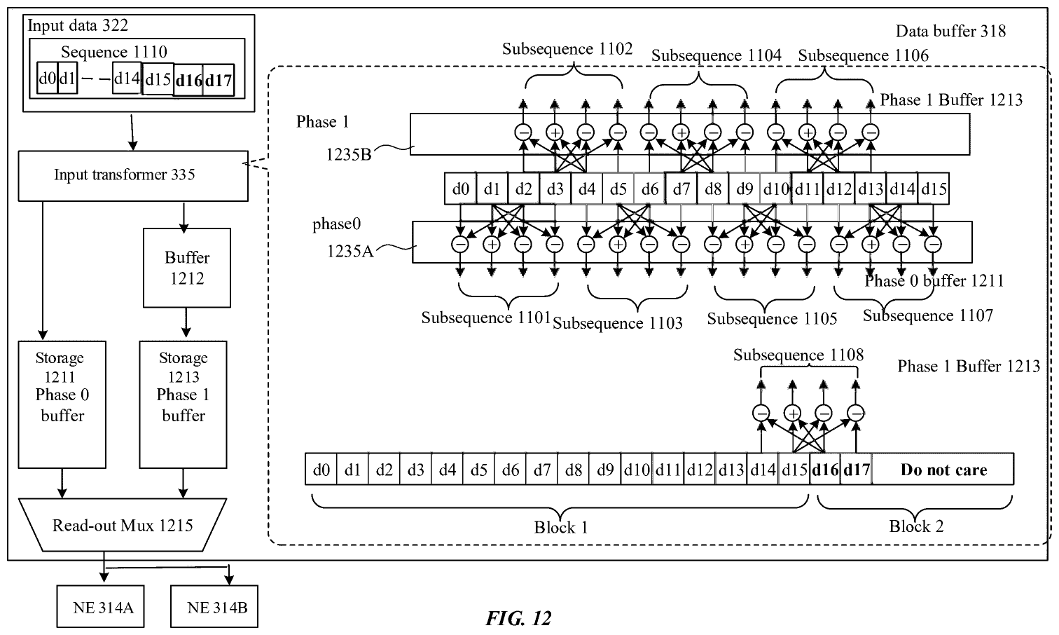

FIG. 12 is a diagram illustrating an input transformer 335 configured to generate intermediate input parameters for multiple pairs of convolutions computed in two phases in a pipelined manner, according to some embodiments. Computations of multiple pairs of convolutions computed in two phases can be performed as illustrated in FIGS. 11A-11C.

In some embodiments, input data 322 can be stored in data buffer 318 that is external to a neural engine and shared by multiple neural engines, e.g., NE 314A and NE 314B. Input data 322 can include sequence 1110 of input parameters (d₀, d₁, d₂, d₃, . . . , d₁₅, d₁₆, d₁₇), where input parameters (d₀, d₁, d₂, d₃, . . . , d₁₅) are from a first block and (d₁₆, d₁₇) are from a second block. In some embodiments, input transformer 335 can include a first input transformer 1235A configured to generate multiple sets of intermediate input parameters corresponding to input parameters (d₀, d₁, d₂, d₃, . . . , d₁₅) that can be divided into 4 subsequences: subsequence 1101, subsequence 1103, subsequence 1105, and subsequence 1107. In addition, input transformer 335 can include a second input transformer 1235B configured to generate multiple sets of intermediate input parameters corresponding to input parameters (d₂, d₃, . . . , d₁₅, d₁₆, d₁₇) that can be divided into 4 subsequences: subsequence 1102, subsequence 1104, subsequence 1106, and subsequence 1108. As shown, subsequence 1108 can include input parameters (d₁₆, d₁₇) contained in the second block. In some embodiments, to perform the operations to generate the intermediate input parameters for subsequence 1101, subsequence 1103, subsequence 1105, subsequence 1107, subsequence 1102, subsequence 1104, subsequence 1106, and subsequence 1108, there can be a total 16*2 adders, where each adder can be a floating point adder. In some embodiments, the number of adders used can depend on the number of the subsequences. Operation results produced by first input transformer 1235A can be stored in storage 1211, which is a phase 0 buffer to store the operation results performed at phase 0. In addition, operation results produced by second input transformer 1235B can be stored in storage 1213, which is a phase 1 buffer to store the operation results performed at phase 1. In some embodiments, there can be an additional buffer 1212 to temporarily store over-fetched data points d₁₆, d₁₇. A multiplexer 1215 can be used to select the intermediate input parameters to be supplied to neural engines, such as NE 314A or NE 314B.

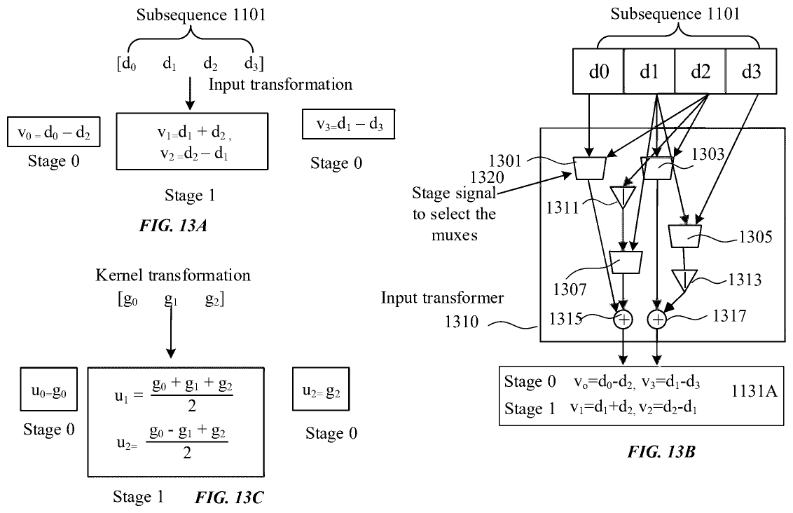

FIGS. 13A-13C are diagrams illustrating two-stage operations of an input transformer and a kernel transformer configured to generate intermediate input parameters and intermediate kernel parameters in two stages, according to some embodiments.

In some embodiments, for subsequence 1101, input transformer 335 can generate set 1131A of intermediate input parameters corresponding to subsequence 1101, as shown in FIG. 11A. For example, input transformer 335 can generate set 1131A having 4 intermediate input parameters (v₀, v₁, v₂, v₃) defined by v₀=(d₀−d₂), v₁=(d₁+d₂), v₂=(d₂−d₁), and v₃=(d₁−d₃). In some embodiments, intermediate input parameters (v₀, v₁, v₂, v₃) can be generated in sequence or in parallel. In some embodiments, intermediate input parameters (v₀, v₁, v₂, v₃) can be generated in two stages as shown in FIG. 13A, where v₀=(d₀−d₂) and v₃=(d₁−d₃) can be generated at stage 0, and v₁=(d₁+d₂) and v₂=(d₂−d₁) can be generated at stage 1.

In some embodiments, an input transformer 1310 shown in FIG. 13B can be used to produce (v₀, v₁, v₂, v₃) in two stages. Input transformer 1310 can include a multiplexer 1301, a multiplexer 1303, a multiplexer 1305, and a multiplexer 1307, in addition to an adder 1315 and an adder 1317. A circuit 1311 and a circuit 1313 can perform operations to derive a negative number of an input number. A stage signal 1320 can be used to select whether operations for stage 0 or stage 1 are performed for all the multiplexers. Accordingly, at stage 0, d₀ can be selected to g₀ through multiplexer 1301 to be supplied to adder 1315, and −d₂ is obtained after circuit 1311 and provided to multiplexer 1307 to be supplied to adder 1315. Hence, adder 1315 can generate v₀=(d₀−d₂) at stage 0. Similarly, adder 1317 can generate v₃=(d₁−d₃) at stage 0. In addition, at stage 1, adder 1315 can generate v₁=(d₁+d₂), where d₂ is supplied through multiplexer 1301, and d₁ is supplied through multiplexer 1307. Furthermore, at stage 1, adder 1317 can generate v₂=(d₂−d₁), where d₂ is supplied through multiplexer 1303, and −d₁ is supplied through multiplexer 1305.

In some embodiments, for other subsequence of input parameters, such as subsequence 1103, an input transformer similar to input transformer 1310 can be used to generate a set 1131B having 4 intermediate input parameters (v₀, v₁, v₂, v₃) defined by v₀=(d₄−d₆), v₁=(d₅+d₆), v₂=(d₆−d₅), and v₃=(d₅−d₇). Similar operations can be performed for other subsequences of input parameters.

In some embodiments, as shown in FIG. 13C, a kernel transformer can be used to generate set 1133 of intermediate kernel parameters, which can include 4 intermediate kernel parameters (u₀, u₁, u₂, u₃) defined by u₀=g₀, u₁=(g₀+g₁+g₂)/2, u₂=(g₀−g₁+g₂)/2, and u₃=g₂, in two stages, where u₀=g₀ and u₃=g₂ can be generated at stage 0, and u₁=(g₀+g₁+g₂)/2 and u₂=(g₀−g₁+g₂)/2 can be generated at stage 1. Kernel transformer for generating intermediate kernel parameters (u₀, u₁, u₂, u₃) can be designed similarly using a number of multiplexers, adders, and a negative number generators as shown in FIG. 13B.

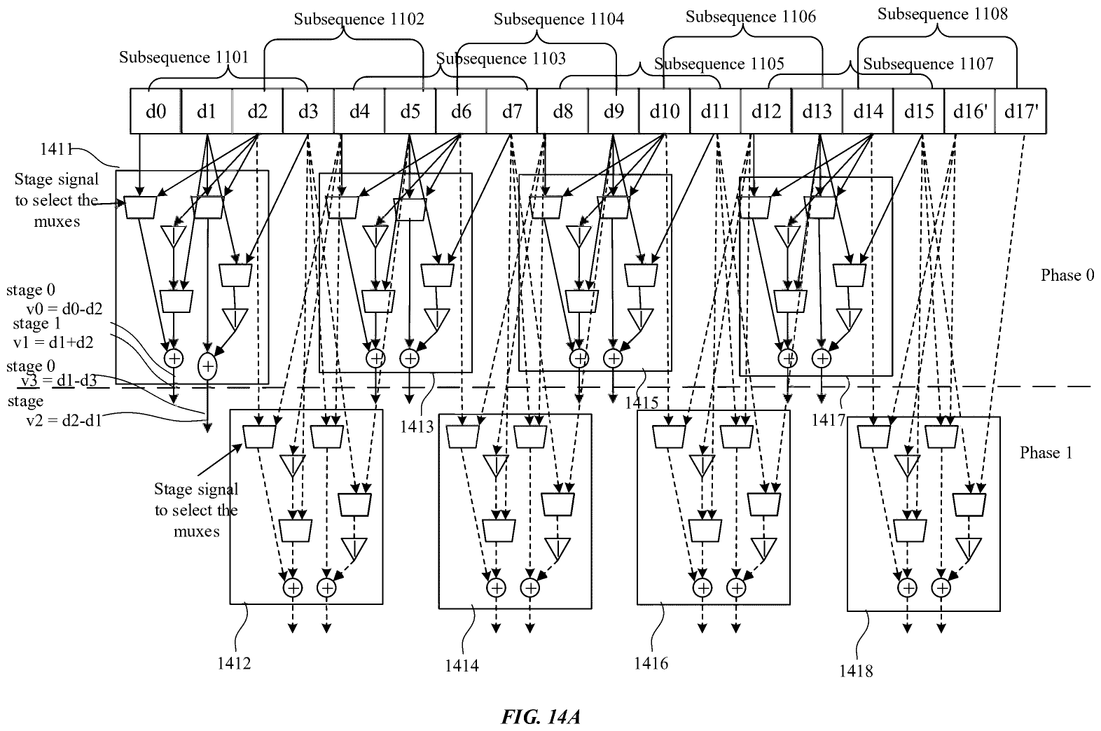

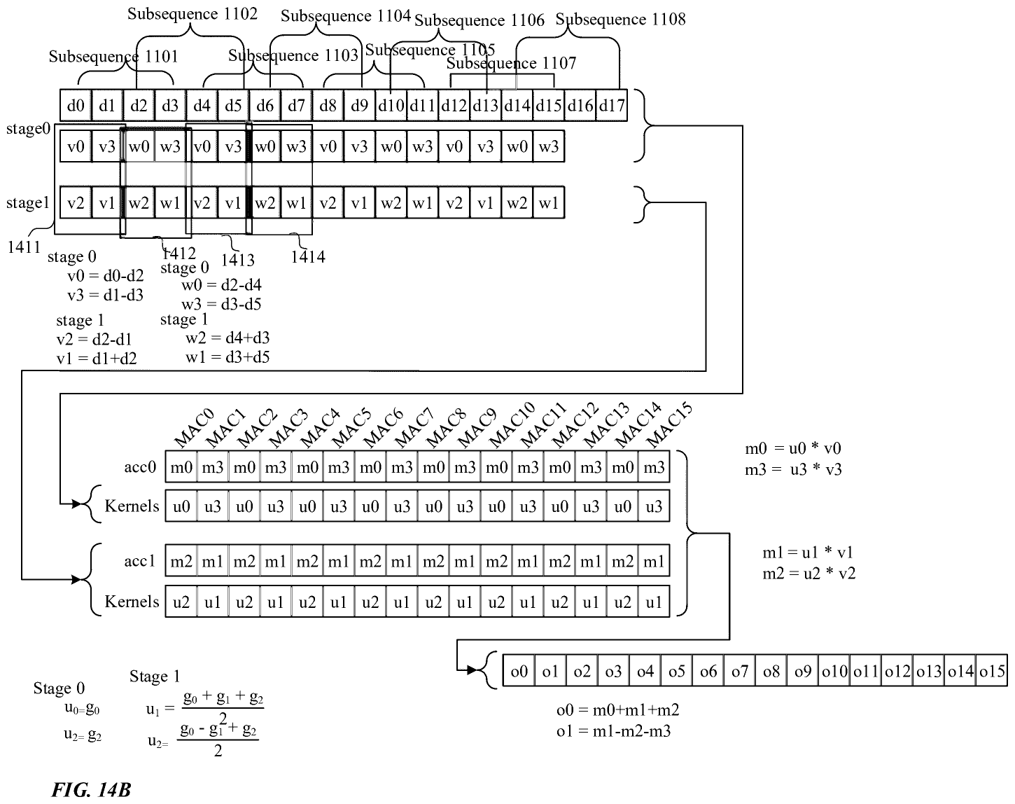

FIGS. 14A-14B are diagrams illustrating multiple pairs of convolutions computed by two-stage input transformers in a pipelined manner to produce the multiple pairs of convolutions, according to some embodiments. Computations illustrated in FIG. 14A are performed by two-stage input transformers in a pipelined manner to generate intermediate input parameters for each subsequence of input parameters. In addition, FIG. 14B illustrates the final convolution values (o₀, o₁, o₂, o₃, o₄, o₅, o₆, o₇, o₈, o₉, o₁₀, o₁₁, o₁₂, o₁₃, o₁₄, o₁₅) are computed in parallel so that the convolution values are available or produced at the same time.

In some embodiments, as shown in FIG. 14A, subsequence 1101 of input parameters are provided to an input transformer 1411 to generate intermediate input parameters v₀=(d₀−d₂) and v₃=(d₁−d₃) at stage 0, and generate intermediate input parameters v₁=(d₁+d₂) and v₂=(d₂−d₁) at stage 1. Similarly, other subsequence of input parameters can be provided to a corresponding input transformer to generate intermediate input parameters. For example, at phase 0, subsequence 1103 of input parameters are provided to an input transformer 1413 to generate intermediate input parameters, subsequence 1105 of input parameters are provided to an input transformer 1415 to generate intermediate input parameters, and subsequence 1107 of input parameters are provided to an input transformer 1417 to generate intermediate input parameters. In addition, at phase 1, subsequence 1102 of input parameters are provided to an input transformer 1412 to generate intermediate input parameters, subsequence 1104 of input parameters are provided to an input transformer 1414 to generate intermediate input parameters, and subsequence 1106 of input parameters are provided to an input transformer 1416 to generate intermediate input parameters, and subsequence 1108 of input parameters are provided to an input transformer 1418 to generate intermediate input parameters.

In some embodiments, a direct implementation of a first group of input transformers, e.g., input transformer 1411, input transformer 1413, input transformer 1415, input transformer 1417, and a second group of input transformers, e.g., input transformer 1412, input transformer 1414, input transformer 1416, input transformer 1418, can each be different by using 8 different input transformers. In addition, the computation can be performed by two stages for each group of input transformers in phase 0 and phase 1. In some embodiments, the first group of input transformers and the second group of input transformers can be shared in a pipelined manner to reduce the hardware used and further improve the computation speed. Instead of computing the two groups of input transformers in two phases, where each phase includes two stages, the computations at two phases and two stages can be merged as shown in FIG. 14B.

In some embodiments, as shown in FIG. 14B, for phase 0 computation, subsequence 1101 of input parameters are provided to input transformer 1411 to generate intermediate input parameters v₀=(d₀−d₂) and v₃=(d₁−d₃) at stage 0 and to generate intermediate input parameters v₁=(d₁+d₂) and v₂=(d₂−d₁) at stage 1. At the same two stages, subsequence 1102 can be provided to input transformer 1412 to generate intermediate input parameters, which are denoted as w0 and w3 at stage 0 and w1 and w2 at stage 1. In some embodiments, computations for subsequence 1102 can be performed at phase 1 instead of phase 0. Hence, by computing intermediate input parameters w0 and w3 at stage 0 and w1 and w2 at stage 1, computations shown in FIG. 14B can merge the two phases of computations into one phase having two stages of computations. Similarly, computations for other subsequences, e.g., subsequence 1103, subsequence 1105, subsequence 1107, subsequence 1102, subsequence 1104, subsequence 1106, and subsequence 1108 can be interleaved to generate the corresponding set of intermediate input parameters, which are alternately denoted as (v0, v3, v1, v2) and (w0, w3, w1, w2). Furthermore, the multiple sets of intermediate input parameters can be provided to two different accumulators, acc0 and acc1, to generate the products m0, m1, m2, and m3 for each subsequence of input parameters and to further generate convolution values (o₀, o₁, o₂, o₃, o₄, o₅, o₆, o₇, o₈, o₉, o₁₀, o₁₁, o₁₂, o₁₃, o₁₄, o₁₅) in parallel at the same time. Accordingly, each subsequence of input parameters, which can be viewed as input parameters for a channel, can use two accumulators. In some embodiments, as shown above, the computation of convolution values (o₀, o₁, o₂, o₃, o₄, o₅, o₆, o₇, o₈, o₉, o₁₀, o₁₁, o₁₂, o₁₃, o₁₄, o₁₅) is for one channel of input parameters and one channel of kernel parameters. In some embodiments, the computation of convolution values can be performed for multiple channels of input parameters and multiple channels of kernel parameters. Accordingly, acc0 and acc1 can be used to accumulate the computation results for multiple channels of input parameters and multiple channels of kernel parameters. After one channel of computation, the values of m₀, m₃ and m₁, m₂ are stored in the accumulators. Afterwards, the same computation can be repeated for the next input channel of image, and the updated values of m₀, m₃ and m₁, m₂ can be accumulated to the previous ones. This process can continue until all input channels are processed. In some embodiments, an accumulator can be implemented as a normal accumulator including a storage to store previous computation results in addition to adders. In some embodiments, an accumulator can be implemented as having adders only depending on the computation performed.

In some embodiments, a neural processor circuit can include an input transformation circuit and a neural engine circuit coupled to the input transformation circuit. The input transformation circuit can be configured to generate, at a first time instance, a first subset of a first set of intermediate input parameters corresponding to a first subsequence of input parameters for a first pair of convolutions, and a first subset of a second set of intermediate input parameters corresponding to a second subsequence of input parameters for a second pair of convolutions. In addition, the input transformation circuit can be configured to generate, at a second time instance, a second subset of the first set of intermediate input parameters, and a second subset of the second set of intermediate input parameters. The neural engine circuit can include a kernel transformation circuit configured to generate at the first time instance a first subset of a set of intermediate kernel parameters based on the number of convolutional kernel parameters and to generate at the second time instance a second subset of the set of intermediate kernel parameters. In addition, the neural engine circuit can include a first accumulator and a second accumulator coupled to the kernel transformation circuit. The first accumulator can be configured to generate a first set of partial results of a first pair of convolution values for the first pair of convolutions and a first set of partial results of a second pair of convolution values for the second pair of convolutions, and the second accumulator can be configured to generate a second set of partial results of the first pair of convolution values, and a second set of partial results of the second pair of convolution values.

In some embodiments, the number of convolutional kernel parameters comprises 3 convolutional kernel parameters (g₀, g₁, g₂), wherein the first subset of the set of intermediate kernel parameters comprises intermediate kernel parameters (u₀, u₃) defined by u₀=g₀ and u₃=g₂, and wherein the second subset of the set of intermediate kernel parameters comprises intermediate kernel parameters (u₁, u₂) defined by u₁=(g₀+g₁+g₂)/2 and u₂=(g₀−g₁+g₂)/2.

In some embodiments, the first subsequence of input parameters can include (d₀, d₁, d₂, d₃), the first subset of the first set of intermediate input parameters comprises intermediate input parameters (v₀, v₃) defined by v₀=(d₀−d₂) and v₃=(d₁−d₃), and wherein the second subset of the first set of intermediate input parameters comprises intermediate input parameters (v₁, v₂) defined by v₁=(d₁+d₂) and v₂=(d₂−d₁). The first set of partial results of the first pair of convolution values comprises 2 products (m₀, m₃) defined by m₀=(u₀·v₀) and m₃=(u₃·v₃), and the second set of partial results of the first pair of convolution values comprises 2 products (m₁, m₂) defined by m₁=(u₁·v₁) and m₂=(u₂·v₂). The first pair of convolution values comprises a first convolution value (o₀) defined by o₀=(m₀+m₁+m₂) and a second convolution value (o₁) defined by o₁=(m₁−m₂−m₃).

In some embodiments, the input transformation circuit can be further configured to generate, at the first time instance, a first subset of a third set of intermediate input parameters corresponding to a third subsequence of input parameters for a third pair of convolutions and generate a first subset of a fourth set of intermediate input parameters corresponding to a fourth subsequence of input parameters for a fourth pair of convolutions. In addition, the input transformation circuit can generate, at the second time instance, a second subset of the third set of intermediate input parameters and a second subset of the fourth set of intermediate input parameters, wherein the third pair of convolutions and the fourth pair of convolutions are based on the number of convolutional kernel parameters. The first accumulator is configured to generate a first set of partial results of a third pair of convolution values for the third pair of convolutions, and a first set of partial results of a fourth pair of convolution values for the fourth pair of convolutions. In addition, the second accumulator is configured to generate a second set of partial results of the third pair of convolution values, and a second set of partial results of the fourth pair of convolution values.

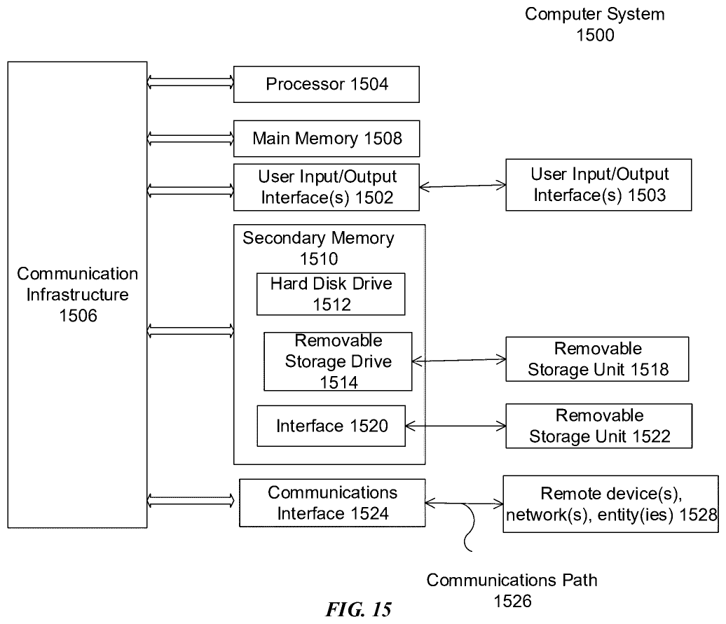

FIG. 15 is an illustration of an example computer system for implementing some embodiments or portion(s) thereof of the disclosure provided herein, according to some embodiments.

Various embodiments can be implemented, for example, using one or more computer systems, such as computer system 1500 shown in FIG. 15. Computer system 1500 can be any computer capable of performing the functions described herein for neural processor circuit 218, neural engine 314 as shown in FIGS. 3B, 3C, 4A, 4B, 8A-8B, 9A-9B, 11A-11C, 12, 13A-13C, and 14A-14B. Computer system 1500 includes one or more processors (also called central processing units, or CPUs), such as a processor 1504. Processor 1504 is connected to a communication infrastructure 1506 (e.g., a bus). Computer system 1500 also includes user input/output device(s) 1503, such as monitors, keyboards, and pointing devices, that communicate with communication infrastructure 1506 through user input/output interface(s) 1502. Computer system 1500 also includes a main or primary memory 1508, such as random access memory (RAM). Main memory 1508 may include one or more levels of cache. Main memory 1508 has stored therein control logic (e.g., computer software) and/or data.

Computer system 1500 may also include one or more secondary storage devices or memory 1510. Secondary memory 1510 may include, for example, a hard disk drive 1512 and/or a removable storage device or drive 1514. Removable storage drive 1514 may be a floppy disk drive, a magnetic tape drive, a compact disk drive, an optical storage device, tape backup device, and/or any other storage device/drive.

Removable storage drive 1514 may interact with a removable storage unit 1518. Removable storage unit 1518 includes a computer usable or readable storage device having stored thereon computer software (e.g., control logic) and/or data. Removable storage unit 1518 may be a floppy disk, magnetic tape, compact disk, DVD, optical storage disk, and/any other computer data storage device. Removable storage drive 1514 reads from and/or writes to removable storage unit 1518 in a well-known manner.

According to some embodiments, secondary memory 1510 may include other means, instrumentalities or other approaches for allowing computer programs and/or other instructions and/or data to be accessed by computer system 1500. Such means, instrumentalities or other approaches may include, for example, a removable storage unit 1522 and an interface 1520. Examples of the removable storage unit 1522 and the interface 1520 may include a program cartridge and cartridge interface (such as that found in video game devices), a removable memory chip (e.g., an EPROM or PROM) and associated socket, a memory stick and USB port, a memory card and associated memory card slot, and/or any other removable storage unit and associated interface.

In some examples, main memory 1508, the removable storage unit 1518, the removable storage unit 1522 can store instructions that, when executed by processor 1504, cause processor 1504 to perform operations for neural processor circuit 218, neural engine 314 as shown in FIGS. 3B, 3C, 4A, 4B, 8A-8B, 9A-9B, 11A-11C, 12, 13A-13C, and 14A-14B.

Computer system 1500 may further include a communication or network interface 1524. Communication interface 1524 enables computer system 1500 to communicate and interact with any combination of remote devices, remote networks, remote entities, and other suitable devices (individually and collectively referenced by reference number 1528). For example, communication interface 1524 may allow computer system 1500 to communicate with remote devices 1528 over communications path 1526, which may be wired and/or wireless, and which may include any combination of LANs, WANs, the Internet, and any other suitable networks. Control logic and/or data may be transmitted to and from computer system 1500 via communication path 1526.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (e.g., software) stored thereon is also referred to as a “computer program product” or “program storage device.” This includes, but is not limited to, computer system 1500, main memory 1508, secondary memory 1510 and removable storage units 1518 and 1522, as well as tangible articles of manufacture embodying any combination of the foregoing. Such control logic, when executed by one or more data processing devices (e.g., computer system 1500), causes such data processing devices to operate as described herein.

Based on the teachings in this disclosure, it will be apparent to persons skilled in the relevant art(s) how to make and use embodiments of the disclosure using data processing devices, computer systems and/or computer architectures other than that shown in FIG. 15. In particular, embodiments may operate with software, hardware, and/or operating system implementations other than those described herein.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like d₀ not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (e.g., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (e.g., having the potential to, being able to) and not in a mandatory sense (e.g., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” and “given circuit”) refer to different instances of the feature. Additionally, the labels “first,” “second,” and “third” when applied to a feature d₀ not imply any type of ordering (e.g., spatial, temporal, and logical), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” and “other components”) may be described or claimed as “configured” to perform one or more tasks or operations. This formulation—[entity] configured to [perform one or more tasks]—is used herein to refer to structure (e.g., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, and latches), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be referred to as “units” (e.g., a decode unit, an arithmetic logic unit (ALU), functional unit, and memory management unit (MMU)). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, and inductors) and interconnect between the transistors and circuit elements. Some embodiments may implement multiple integrated circuits coupled to one another to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits may result in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A neural processor circuit, comprising:
a data storage device configured to store input data comprising a sequence of input parameters including a first group of input parameters for a first convolution and a second group of input parameters for a second convolution, wherein the first convolution is between the first group of input parameters and a number of convolutional kernel parameters, and wherein the second convolution is between the second group of input parameters and the number of convolutional kernel parameters; and
a neural engine circuit comprising:
a kernel transformation circuit configured to:
receive the number of convolutional kernel parameters from a system memory; and
generate a number of intermediate kernel parameters, wherein the number of intermediate kernel parameters is larger than the number of convolutional kernel parameters; and
a plurality of multipliers corresponding to the number of intermediate kernel parameters, wherein a multiplier of the plurality of multipliers is configured to multiply an intermediate kernel parameter by an intermediate input parameter of a plurality of intermediate input parameters generated based on the first group of input parameters and the second group of input parameters.

2. The neural processor circuit of claim 1, wherein the system memory is external to the neural processor circuit and shared by the neural processor circuit and other neural processor circuits.

3. The neural processor circuit of claim 1, wherein the neural engine circuit further comprises a first accumulator and a second accumulator, wherein the first accumulator is configured to generate a first convolution value of the first convolution, wherein the second accumulator is configured to generate a second convolution value of the second convolution, and wherein the first convolution value and the second convolution value are generated in parallel.

4. The neural processor circuit of claim 1, wherein the neural engine circuit further comprises an input transformation circuit configured to:
receive the first group of input parameters and the second group of input parameters; and
generate the plurality of intermediate input parameters.

5. The neural processor circuit of claim 1, wherein the data storage device comprises an input transformation circuit shared by the neural engine circuit and other neural engine circuits, wherein the input transformation circuit is configured to generate the plurality of intermediate input parameters.

6. The neural processor circuit of claim 1, wherein the first convolution is associated with a first data point representing a first pixel of an image and the second convolution is associated with a second data point representing a second pixel of the image adjacent to the first pixel in a row of the image.

7. The neural processor circuit of claim 1, wherein the first group of input parameters and the second group of input parameters share a plurality of common input parameters.

8. A method performed by a neural processor circuit, comprising:
receiving input data comprising a sequence of input parameters comprising a first group of input parameters for a first convolution and a second group of input parameters for a second convolution, wherein the first convolution is between the first group of input parameters and a number of convolutional kernel parameters, and wherein the second convolution is between the second group of input parameters and the number of convolutional kernel parameters;
generating a number of intermediate kernel parameters, wherein the number of intermediate kernel parameters is larger than the number of convolutional kernel parameters;
generating a plurality of intermediate input parameters based on the first group of input parameters and the second group of input parameters; and
multiplying an intermediate kernel parameter by an intermediate input parameter of the plurality of intermediate input parameters.

9. The method of claim 8, wherein the number of convolutional kernel parameters comprises 3 convolutional kernel parameters (g₀, g₁, g₂), the first group of input parameters comprises 3 input parameters (d₀, d₁, d₂), the second group of input parameters comprises 3 input parameters (d₁, d₂, d₃), wherein a first convolution value (o₀) of the first convolution between the first group of input parameters and the number of convolutional kernel parameters is defined by o₀=(d₀·g₀)+(d₁·g₁)+(d₂·g₂), and wherein a second convolution value (o₁) of the second convolution between the second group of input parameters and the number of convolutional kernel parameters is defined by o₁=(d₁·g₀)+(d₂·g₁)+(d₃·g₂).

10. The method of claim 9, wherein the number of intermediate kernel parameters comprises 4 intermediate kernel parameters (u₀, u₁, u₂, u₃) defined by u₀=g₀, u₁=(g₀+g₁+g₂)/2, u₂=(g₀−g₁+g₂)/2, and u₃=g₂.

11. The method of claim 10, wherein the first convolution value (o₀) and the second convolution value (o₁) are generated based on 4 intermediate input parameters (v₀, v₁, v₂, v₃) defined by v₀=(d₀−d₂), v₁=(d₁+d₂), v₂=(d₂−d₁), and v₃=(d₁−d₃).

12. The method of claim 11, further comprising:
generating 4 products (m₀, m₁, m₂, m₃) defined by m₀=(u₀·v₀), m₁=(u₁·v₁), m₂=(u₂·v₂), and m₃=(u₃·v₃).

13. The method of claim 12, further comprising:
generating the first convolution value (o₀) defined by o₀=(m₀+m₁+m₂); and
generating the second convolution value (o₁) defined by o₁=(m₁−m₂−m₃).

14. A neural processor circuit, comprising:
a data storage device configured to store input data comprising a sequence of input parameters including a first group of input parameters for a first convolution and a second group of input parameters for a second convolution, wherein the first convolution is between the first group of input parameters and a number of convolutional kernel parameters, and wherein the second convolution is between the second group of input parameters and the number of convolutional kernel parameters; and
a neural engine circuit comprising:
a kernel transformation circuit configured to generate a number of intermediate kernel parameters, wherein the number of intermediate kernel parameters is larger than the number of convolutional kernel parameters;
a plurality of multipliers corresponding to the number of intermediate kernel parameters, wherein a multiplier of the plurality of multipliers is configured to multiply an intermediate kernel parameter by an intermediate input parameter of a plurality of intermediate input parameters generated based on the first group of input parameters and the second group of input parameters;
a first accumulator configured to generate a first convolution value of the first convolution; and
a second accumulator configured to generate a second convolution value of the second convolution.

15. The neural processor circuit of claim 14, wherein the sequence of input parameters is a first subsequence of input parameters, each input parameter of the first subsequence of input parameters having an ordered index in increasing order for indices of the first subsequence of input parameters, and wherein the second group of input parameters is obtained by shifting the first group of input parameters by one index within the first subsequence of input parameters, and the input data further comprises a second subsequence of input parameters including:
a third group of input parameters for a third convolution based on the number of intermediate kernel parameters; and
a fourth group of input parameters for a fourth convolution based on the number of intermediate kernel parameters.

16. The neural processor circuit of claim 15, wherein a multiplier of the plurality of multipliers is configured to multiply the intermediate kernel parameter by an intermediate input parameter selected from a plurality of intermediate input parameters generated based on the third group of input parameters and the fourth group of input parameters.

17. The neural processor circuit of claim 16, wherein the neural engine circuit further comprises:
a third accumulator configured to generate a third convolution value of the third convolution; and
a fourth accumulator configured to generate a fourth convolution value of the fourth convolution.

18. The neural processor circuit of claim 17, wherein a union sequence of the first subsequence of input parameters and the second subsequence of input parameters comprises:
a fifth group of input parameters for a fifth convolution based on the number of intermediate kernel parameters; and
a sixth group of input parameters for a sixth convolution based on the number of intermediate kernel parameters, wherein the fifth group of input parameters is obtained by shifting indices of the first group of input parameters within the union sequence.

19. The neural processor circuit of claim 18, wherein:
the first accumulator is configured to generate the first convolution value of the first convolution at a first time instance and generate a fifth convolution value of the fifth convolution at a second time instance; and
the second accumulator is configured to generate the second convolution value of the second convolution at the first time instance and generate a sixth convolution value of the sixth convolution at the second time instance.

20. The neural processor circuit of claim 18, wherein the first convolution is associated with a first data point representing a first pixel of an image, the second convolution is associated with a second data point representing a second pixel of the image adjacent to the first pixel in a row of the image, the third convolution is associated with a third data point representing a third pixel of the image, the fourth convolution is associated with a fourth data point representing a fourth pixel of the image, the fifth convolution is associated with a fifth data point representing a fifth pixel of the image, the sixth convolution is associated with a sixth data point representing a sixth pixel of the image, and wherein the fifth data point and the sixth data point are located in the row of the image between a group of the first data point and the second data point and another group of the third data point and the fourth data point.
